(19) United States
(12) Patent Application Publication
(10) Pub. No.: US 2005/0075416 A1
(43) Pub. Date: Apr. 7, 2005

(54) Process for preparing microencapsulated pigment, microencapsulated pigment, aqueous dispersion, and ink for ink jet recording

(75) Inventor: Toshiyuki Miyabayashi, Nagano (JP)

Correspondence Address: Clifford J. Mass;Ladas & Parry, 26 West 61 Street, New York, NY, 10023, US

(73) Assignee: SEIKO EPSON CORPORATION

(21) Appl. No.: 10/782,747

(22) Filed: Feb. 19, 2004

(30) Foreign Application Priority Data
Aug. 29, 2003 (JP) P.2003-307852
Feb. 21, 2003 (JP) P.2003-44642
Feb. 19, 2004 (JP) P.2004-43396

(51) Int. Cl. C03C 17/00; C09D 5/00

(52) U.S. Cl. 523/160; 523/161

(57) ABSTRACT

The present invention relates to a process for preparing a microencapsulated pigment, which comprises adding a polymerizable surfactant having a hydrophilic group, a hydrophobic group and a polymerizable group, a polymerization initiator and an aqueous medium to a wet pigment, and conducting emulsion polymerization to encapsulate pigment particles with a polymer. Also disclosed are a microencapsulated pigment obtained by using this preparation process and an ink for ink jet recording containing at least the microencapsulated pigment and water.

### FIELD OF THE INVENTION

The present invention relates to a process for preparing a microencapsulated pigment, an aqueous dispersion and an ink for ink jet recording.

### BACKGROUND OF THE INVENTION

An ink jet recording process is a process comprising ejecting ink droplets from a fine nozzle head to form letters or figures on a surface of a recording medium such as paper. As the ink jet recording process, there has been put to practical use a process in which electric signals are converted to mechanical signals with an electrostrictive element, thereby intermittently ejecting ink droplets stored in a nozzle head section to record letters or symbols on a surface of a recording medium, a process in which part of an ink solution is rapidly heated at a portion close to an ejection portion of a nozzle head to generate bubbles, and ink droplets are intermittently ejected by volume expansion due to the bubbles to record letters or symbols on a surface of a recording medium, or the like.

As an ink for ink jet recording, there has recently been provided an aqueous pigment ink in which a pigment is dispersed in water. This is because an ink using a pigment is characterized by excellent water resistance and light resistance, compared to an ink using a water-soluble dye. In such an aqueous pigment ink, it has been generally carried out that the pigment is dispersed in an aqueous dispersing medium with a dispersant such as a surfactant or a polymer dispersant.

In a pigment ink using an acetylene glycol-based penetrant, it has been studied to use a polymer dispersant as the dispersant for pigment particles, and water, a non-volatile organic solvent or a lower alcohol as the aqueous medium, thereby securing dispersion stability thereof (for example, see patent document 1). However, when the dispersant is used for dispersion of the pigment particles as described above, elements in ink preparation are increased, which makes it difficult to set ink physical properties such as viscosity to desired values. Further, also in this pigment ink, the problem that print density is difficult to be secured is not solved yet.

Furthermore, in the aqueous pigment ink, the dispersant is merely adsorbed on surfaces of the pigment particles. Accordingly, when the ink solution is ejected through fine nozzles of a recording head, strong shear force is applied thereto, so that the dispersant adsorbed on the surfaces of the pigment particles is eliminated to deteriorate dispersibility, resulting in recognition of the tendency of ejection to become unstable in some cases. Moreover, when the above-mentioned aqueous pigment ink is stored for a long period of time, the tendency of ejection to become unstable is also recognized in some cases.

As another technique for dispersing pigment particles in water, there has been proposed a technique of introducing a sulfonic acid group onto a surface of the pigment particle. A pigment ink has been known which contains a surface-sulfonated organic pigment obtained by treating with a sulfonating agent an organic pigment dispersed in an active proton-free solvent (related art 1; for example, see patent document 2). According to related art 1, it has been said that the above-mentioned pigment ink has excellent dispersion stability, and good ejection stability from the nozzles of the recording head (the characteristic of being stably ejected from the recording head to a definite direction).

Further, it has been known that an organic pigment mass whose surface is positively chargeable is prepared by treating a sulfonic acid group-introduced organic pigment mass with a monovalent metallic ion. Furthermore, there have been known an aqueous ink composition excellent in storage stability (dispersion stability) containing fine pigment particles prepared from the organic pigment mass whose surface is positively chargeable, a dispersant and water (related art 2; for example, see patent document 3).

However, although an ink using the surface-treated pigment particles of the above-mentioned related art 1 or related art 2 as a colorant is excellent in dispersion stability and ejection stability, compared to conventional pigment-based inks for ink jet recording, abrasion resistance of recorded matter obtained by printing on a recording medium such as plain paper or a recording medium for ink jet recording (a recording medium having provided on a surface thereof an ink receiving layer for receiving an ink for ink jet recording) has still been insufficient. This is considered to be due to insufficient fixability of the above-mentioned surface-treated pigment particles to the recording medium.

On the other hand, in order to improve fixability of a pigment contained in a pigment-based ink jet recording ink to a recording medium, a technique using a microencapsulated pigment in which a colorant particles are encapsulated with a polymer has been known (for example, see patent documents 4 to 36). Encapsulated fine pigment particles are known in patent documents 4 and 5, and pigment particles in which a polymer is graft polymerized on surfaces thereof are known in patent documents 6 to 9. Patent document 10 proposes a method for microencapsulating a hydrophobic powder with an amphiphilic graft polymer. However, the use of a previously polymerized polymer in microencapsulating has raised the problem that the particle size after encapsulation becomes too large. Patent documents 11 to 19 propose inks containing pigments encapsulated with resins having film forming properties at room temperature by phase reversal of emulsion, and patent documents 20 to 29 propose inks using pigments encapsulated with anionic group-containing organic polymer compounds by acid precipitation.

Further, patent documents 30 to 35 propose inks using polymer emulsions in which fine polymer particles are impregnated with colorants by phase reversal of emulsion (related art 3). However, in the colorant obtained by phase reversal of emulsion or acid precipitation, the polymer adsorbed on the pigment particles is also sometimes eliminated and dissolved in the ink, depending on the kind of organic solvent such as a penetrant used in the ink, so that dispersion stability and ejection stability of the ink, image quality and the like have been insufficient in some cases. In the ink of related art 3, the polymer adsorbed on the pigment particles is not a little eliminated, so that the pigment content in the ink is limited from the point of dispersion stability.

Further, in patent document 36, a technique is known in which a polymerizable surfactant and an aqueous medium are added to pigment particles to prepare an emulsion of the pigment particles, and the polymerizable surfactant is polymerized to microencapsulate the pigment particles (related art 4). However, also in this case, dispersion stability and ejection stability of the ink, image quality and the like are still insufficient, so that the pigment content in the ink is limited from the point of dispersion stability.

From the above, images of recorded matter obtained by using the inks in which the microencapsulated pigments of related art 3 and related art 4 are used as the colorants have low print density. In particular, when plain paper is used as the recording medium, there have been the problems that blurring is liable to occur in images, and that color developability is also low.
Patent Document 1: JP 3-157464 A
Patent Document 2: JP 10-110129 A
Patent Document 3: JP 11-49974 A
Patent Document 4: JP 7-94634 B
Patent Document 5: JP 8-59715 A
Patent Document 6: JP 5-339516 A
Patent Document 7: JP 8-302227 A
Patent Document 8: JP 8-302228 A
Patent Document 9: JP 8-81647 A
Patent Document 10: JP 5-320276 A
Patent Document 11: JP 8-218015 A
Patent Document 12: JP 8-295837 A
Patent Document 13: JP 9-3376 A
Patent Document 14: JP 8-183920 A
Patent Document 15: JP 10-46075 A
Patent Document 16: JP 10-292143 A
Patent Document 17: JP 11-80633 A
Patent Document 18: JP 11-349870 A
Patent Document 19: JP 2000-7961 A
Patent Document 20: JP 9-31360 A
Patent Document 21: JP 9-217019 A
Patent Document 22: JP 9-316353 A
Patent Document 23: JP 9-104834 A
Patent Document 24: JP 9-151342 A
Patent Document 25: JP 10-140065 A
Patent Document 26: JP 11-152424 A
Patent Document 27: JP 11-166145 A
Patent Document 28: JP 11-199783 A
Patent Document 29: JP 11-209672 A
Patent Document 30: JP 9-286939 A
Patent Document 31: JP 2000-44852 A
Patent Document 32: JP 2000-53897 A
Patent Document 33: JP 2000-53898 A
Patent Document 34: JP 2000-53899 A
Patent Document 35: JP 2000-53900 A
Patent Document 36: JP 10-316909 A

### SUMMARY OF THE INVENTION

The invention has been made in view of the above-mentioned problems, and an object of the invention is to provide a process for preparing a microencapsulated pigment capable of preparing an ink for ink jet recording satisfying all the following (1) to (6), a microencapsulated pigment and an aqueous dispersion.
(1) Excellent in dispersion stability;
(2) Excellent in ejection stability from a recording head;
(3) Capable of obtaining recorded matter excellent in fastness of images;
(4) Capable of obtaining recorded matter excellent in print density of images;
(5) Capable of obtaining recorded matter excellent in abrasion resistance of images; and
(6) Capable of obtaining recorded matter in which images are hard to blur, and which is excellent in color developability of images, even when plain paper is used as a recording medium.

Another object of the invention is to provide an ink for ink jet recording satisfying all the above-mentioned (1) to (6).

Other objects and effects of the invention will become apparent from the following description.

As a result of extensive studies, the present inventors have discovered that an ink for ink jet recording satisfying all the above-mentioned (1) to (6) can be surprisingly obtained by preparing a specific microencapsulated pigment, and using the microencapsulated pigment as a colorant for the ink for ink jet recording, thus having completed the invention. That is, technical constitution of the invention is as follows:

[1] A process for preparing a microencapsulated pigment, which comprises adding a polymerizable surfactant having a hydrophilic group, a hydrophobic group and a polymerizable group, a polymerization initiator and an aqueous medium to a wet pigment, and conducting emulsion polymerization to encapsulate pigment particles with a polymer.

[2] A process for preparing a microencapsulated pigment, which comprises adding a polymerizable surfactant having a hydrophilic group, a hydrophobic group and a polymerizable group, a comonomer copolymerizable with the above-mentioned polymerizable surfactant, a polymerization initiator and an aqueous medium to a wet pigment, and conducting emulsion polymerization to encapsulate pigment particles with a copolymer.

[3] The process described in the above [2], wherein the above-mentioned comonomer is a hydrophilic monomer and/or a hydrophobic monomer.

[4] The process described in the above [3], wherein the above-mentioned hydrophobic monomer has at least a hydrophobic group and a polymerizable group in its structure, and the hydrophobic group is selected from the group consisting of aliphatic hydrocarbon groups, alicyclic hydrocarbon groups and aromatic hydrocarbon groups.

[5] The process described in the above [3], wherein the above-mentioned hydrophilic monomer has at least a hydrophilic group and a polymerizable group in its structure, and the hydrophilic group is selected from the group consisting of a sulfonic acid group, a sulfinic acid group, a carboxyl group, a carbonyl group, salts of these groups, a hydroxyl group, an oxyethylene group, an amido group and an amino group.

[6] The process described in any one of the above [2] to [5], wherein the polymerizable group of the above-mentioned comonomer is a radically polymerizable unsaturated hydrocarbon group selected from the group consisting of a vinyl group, an allyl group, an acryloyl group, a methacryloyl group, a propenyl group, a vinylidene group and a vinylene group.

[7] The process described in any one of the above [1] to [6], wherein the pigment constituting the above-mentioned pigment particles is carbon black or an organic pigment.

[8] The process described in any one of the above [1] to [7], wherein the polymerizable group of the above-mentioned polymerizable surfactant is a group selected from the group consisting of a vinyl group, an allyl group, an acryloyl group, a methacryloyl group, a propenyl group, a vinylidene group and a vinylene group.

[9] The process described in any one of the above [1] to [8], wherein the hydrophilic group of the above-mentioned polymerizable surfactant is an anionic group selected from the group consisting of a sulfonic acid group, a sulfinic acid group, a carboxyl group, a carbonyl group and salts of these groups, and/or a nonionic group selected from the group consisting of a hydroxyl group and an oxyethylene group.

[10] The process described in any one of the above [1] to [9], wherein the hydrophobic group of the above-mentioned polymerizable surfactant is a group selected from the group consisting of alkyl groups, aryl groups and combinations thereof.

[11] A microencapsulated pigment obtained by using the process according to any one of the above [1] to [10].

[12] The microencapsulated pigment described in the above [11], which has an aspect ratio of 1.0 to 1.3, and a Zingg index of 1.0 to 1.3.

[13] An aqueous dispersion containing the microencapsulated pigment described in the above [11] or [12].

[14] An ink for ink jet recording containing the aqueous dispersion described in the above [13].

[15] An ink for ink jet recording containing an aqueous dispersion of a microencapsulated pigment in which pigment particles are encapsulated with a polymer,
wherein the above-mentioned microencapsulated pigment is formed by adding a polymerizable surfactant having a hydrophilic group, a hydrophobic group and a polymerizable group, a polymerization initiator and an aqueous medium to a wet pigment, and conducting emulsion polymerization, and
wherein the above-mentioned aqueous dispersion has been subjected to purification treatment, and the concentration of unreacted polymerizable surfactant after the above-mentioned purification treatment is 50000 ppm or less based on the aqueous component in the above-mentioned aqueous dispersion.

[16] An ink for ink jet recording containing an aqueous dispersion of a microencapsulated pigment in which pigment particles are encapsulated with a polymer,
wherein the above-mentioned microencapsulated pigment is formed by adding a polymerizable surfactant having a hydrophilic group, a hydrophobic group and a polymerizable group, a comonomer copolymerizable with the above-mentioned polymerizable surfactant, a polymerization initiator and an aqueous medium to a wet pigment, and conducting emulsion polymerization, and
wherein the above-mentioned aqueous dispersion has been subjected to purification treatment, and the total concentration of unreacted polymerizable surfactant and comonomer after the above-mentioned purification treatment is 50000 ppm or less based on the aqueous component in the above-mentioned aqueous dispersion.

[17] An ink for ink jet recording containing at least the microencapsulated pigment described in the above [11] or [12] and water.

[18] The ink for ink jet recording described in any one of the above [14] to [17], further containing a water-soluble organic solvent.

[19] The ink for ink jet recording described in the above [18], wherein the above-mentioned water-soluble organic solvent is a high boiling water-soluble organic solvent having a boiling point of 180° C. or higher.

[20] The ink for ink jet recording described in the above [18] or [19], wherein the above-mentioned water-soluble organic solvent contains at least one compound selected from the group consisting of glycerol, an alkyl ether of a polyhydric alcohol and an 1,2-alkyldiol.

[21] The ink for ink jet recording described in any one of the above [14] to [20], further containing a solid wetting agent in an amount of 3% to 20% by weight based on the total weight of the above-mentioned ink for ink jet recording.

[22] The ink for ink jet recording described in the above [21], wherein the above-mentioned solid wetting agent is trimethylolpropane and/or 1,2,6-hexanetriol.

[23] The ink for ink jet recording described in any one of the above [14] to [22], further containing a surfactant.

[24] The ink for ink jet recording described in the above [23], wherein the above-mentioned surfactant is an acetylene glycol-based surfactant and/or an acetylene alcohol-based surfactant.

[25] The ink for ink jet recording described in any one of the above [14] to [24], further containing a saccharide.

As described above, according to the microencapsulated pigment and the process for preparing the same of the invention, there can be provided a microencapsulated pigment capable of preparing an ink for ink jet recording satisfying all the following (1) to (6) and a process for preparing the same, and an aqueous dispersion.
(1) Excellent in dispersion stability;
(2) Excellent in ejection stability from a recording head;
(3) Capable of obtaining recorded matter excellent in fastness of images;
(4) Capable of obtaining recorded matter excellent in print density of images;
(5) Capable of obtaining recorded matter excellent in abrasion resistance of images; and
(6) Capable of obtaining recorded matter in which images are hard to blur, and which is excellent in color developability of images, even when plain paper is used as a recording medium.

Further, according to the ink for ink jet recording of the invention, there can be provided an ink for ink jet recording satisfying all the following (1) to (6):
(1) Excellent in dispersion stability;
(2) Excellent in ejection stability from a recording head;
(3) Capable of obtaining recorded matter excellent in fastness of images;
(4) Capable of obtaining recorded matter excellent in print density of images;
(5) Capable of obtaining recorded matter excellent in abrasion resistance of images; and
(6) Capable of obtaining recorded matter in which images are hard to blur, and which is excellent in color developability of images, even when plain paper is used as a recording medium.

### BRIEF DESCRIPTION OF THE DRAWINGS

FIG. 1 is a schematic view showing a state in which pigment particles are dispersed in an aqueous medium and coexist with a polymerizable surfactant.

FIG. 2 is a schematic view showing a state in which the polymerizable surfactant is polymerized in the dispersed state shown in FIG. 1.

Reference numerals used in the drawings represent the following:
1: Pigment Particle
2: Polymerizable Surfactant
11: Hydrophilic Group
12: Hydrophobic Group
13: Polymerizable Group
60: Polymer Layer (Polymer)
100: Microencapsulated Pigment

### DETAILED DESCRIPTION OF THE INVENTION

The process for preparing a microencapsulated pigment according to the invention is characterized in that a polymerizable surfactant having a hydrophilic group, a hydrophobic group and a polymerizable group, a polymerization initiator and an aqueous medium-are added to a wet pigment, and pigment particles are encapsulated with a polymer by conducting emulsion polymerization.

Further, the process for preparing a microencapsulated pigment according to the invention is characterized in that a polymerizable surfactant having a hydrophilic group, a hydrophobic group and a polymerizable group, a comonomer copolymerizable with the above-mentioned polymerizable surfactant, a polymerization initiator and an aqueous medium are added to a wet pigment, and pigment particles are encapsulated with a copolymer by conducting emulsion polymerization.

According to such a preparation process, the hydrophobic group of the polymerizable surfactant is adsorbed on a hydrophobic surface of the pigment particle of the wet pigment by a hydrophobic interaction to bring about a state in which the hydrophilic group is directed toward a direction in which the aqueous medium exists, that is, toward an aqueous phase side. The hydrophilic group can be introduced onto the surface of the pigment particle in a highly controlled form by conducting a polymerization reaction with the polymerization initiator in this state. Further, also when the comonomer is used, the hydrophilic groups are regularly densely orientated toward a direction in which the aqueous medium exists, that is, toward an aqueous phase side, and a comonomer-derived polymer layer is formed between the pigment particle and the hydrophilic group derived from the polymerizable surfactant, which makes it possible to form a highly controlled capsule structure. Accordingly, the microencapsulated pigment according to an embodiment of the invention is capable of preparing an ink for ink jet recording satisfying all the following (1) to (6):
(1) Excellent in dispersion stability;
(2) Excellent in ejection stability from a recording head;
(3) Capable of obtaining recorded matter excellent in fastness of images;
(4) Capable of obtaining recorded matter excellent in print density of images;
(5) Capable of obtaining recorded matter excellent in abrasion resistance of images; and
(6) Capable of obtaining recorded matter in which images are hard to blur, and which is excellent in color developability of images, even when plain paper is used as a recording medium.

In the case of a microencapsulated pigment in which a pigment is encapsulated with a polymer previously prepared by phase reversal of emulsion or acid precipitation, a state of pigment particles encapsulated with the polymer is determined by the structure of the polymer. It is therefore considered that such a state of pigment particles encapsulated with the polymer that all the above-mentioned (1) to (6) are satisfied has not been achieved.

Here, it is preferred that the microencapsulated pigment of the invention has an aspect ratio (long-short degree) of 1.0 to 1.3, and a Zingg index of 1.0 to 1.3 (more preferably 1.0 to 1.2), thereby being able to satisfy the above-mentioned (1), (2), (4) and (6) more securely.

When the minor diameter, major diameter and thickness of a particle are taken as b, l and t (l≧b≧t≧0), respectively, the aspect ratio (long-short degree) is l/b (≧1), the degree of flatness is b/t (≧1), and the Zingg index is the long-short degree/the degree of flatness=(l·t)/b². That is, the true sphere has an aspect ratio of 1 and a Zingg index of 1.

When the aspect ratio is larger than 1.3, the microencapsulated pigment becomes flatter in shape to lower the isotropy. This perhaps accounts for the fact that there is a tendency to fail to obtain sufficient results, particularly with respect to the above (1), (2), (4) and (6). Although there is no particular limitation on the method for adjusting the aspect ratio and the Zingg index within the above-mentioned ranges, the aspect ratio and the Zingg index can be adjusted more securely within the above-mentioned ranges by using methods according to embodiments of the invention described later. As for microencapsulated pigments prepared by methods other than emulsion polymerization, such as acid precipitation and phase reversal of emulsion, it is difficult to adjust the aspect ratio and the Zingg index within the above-mentioned ranges.

The aspect ratio and Zingg index of the microencapsulated pigment of the invention are easily adjusted within the above-mentioned ranges, so that the pigment is shaped like a true sphere. Accordingly, an ink using the microencapsulated pigment of the invention easily becomes Newtonian in its fluid characteristics, and is also excellent in the dispersibility of the microencapsulated pigment in the ink, which remarkably stabilizes ejection from ink jet nozzles. Further, the microencapsulated pigment of the invention shaped like a true sphere brings about the densest packing of the microencapsulated pigment on a recording medium (coating a surface of the recording medium at high density), when the ink lands on the recording medium such as paper. Accordingly, printing by the ink using the microencapsulated pigment of the invention provides high print density, and can also provide good color developability.

The invention will be described in detail below, with reference to dispersed states of pigment particles which can occur in the method for preparing the microencapsulated pigment of the invention. The dispersed states of the pigment particles described below include assumptions.

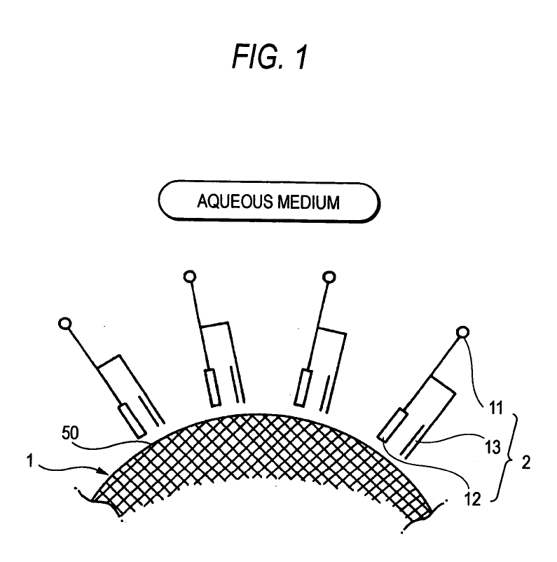

FIG. 1 is a view showing a state in which pigment particle 1 is dispersed in a solvent containing water as a main component (hereinafter also referred to as an aqueous medium), and coexists with a polymerizable surfactant 2 having a hydrophilic group 11, a hydrophobic group 12 and a polymerizable group 13. A surface 50 of the pigment particle 1 forms a hydrophobic region herein. The polymerizable surfactant 2 is adsorbed so that the hydrophobic group 12 is directed toward the pigment particle 1 by an interaction of the hydrophobic group 12 with the hydrophobic region 50. The hydrophilic group 11 of the polymerizable surfactant 2 is directed toward a direction in which the aqueous medium exists, that is, a direction departing from the pigment particle 1.

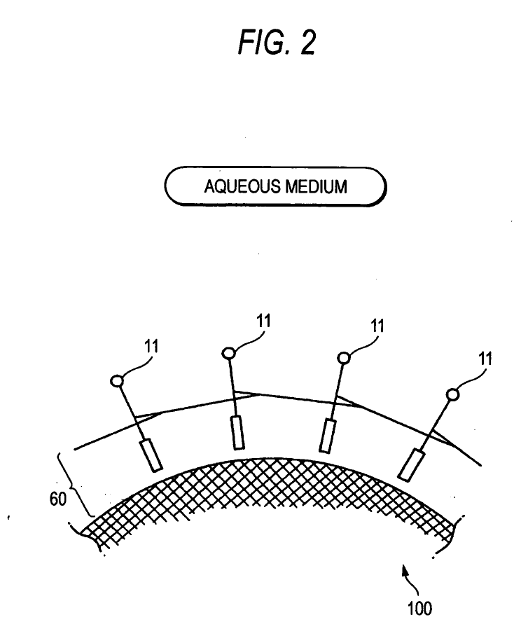

To such an aqueous dispersion, for example, a polymerization initiator is added to polymerize the polymerizable groups 13 of the polymerizable surfactant 2, thereby preparing a microencapsulated pigment 100 in which the pigment particle 1 is encapsulated with a polymer layer 60, as shown in FIG. 2. A surface of the polymer layer 60 has the hydrophilic group 11, so that the microencapsulated pigment 100 is dispersible in the aqueous medium. At the time of polymerization, a comonomer copolymerizable with the polymerizable surfactant 2 may be allowed to exist in the aqueous dispersion as needed. In that case, the polymer layer 60 can be a copolymer layer copolymerized from the polymerizable surfactant 2 and the comonomer.

The microencapsulated pigment described above is first in a state in which it is dispersed in the aqueous medium by the arrangement of the polymerizable surfactant 2 around the pigment particle 1. A wet pigment is used in the pigment particle 1 in the aqueous medium, so that the pigment particle 1 is finely dispersible compared to an aqueous dispersion in which a dry powder of a pigment is used. According to such a microencapsulated pigment of the embodiment in which the pigment particles are encapsulated with the polymer, the hydrophilic groups on the surface of the microencapsulated pigment are regularly densely orientated toward a direction in which the aqueous medium exists as shown in FIG. 2. Accordingly, effective electrostatic repulsion is generated among the microencapsulated pigments, thereby being able to improve dispersion stability of the microencapsulated pigment in the aqueous medium. This provides the ink for ink jet recording using the microencapsulated pigment of the invention, which is excellent in ejection stability of the ink from an ink jet head in an ink jet recording process, compared to a conventional pigment ink. Further, when the amount of the microencapsulated pigment contained in the ink is increased, the pigment excellent in dispersibility and dispersion stability is also obtained. It is therefor possible to prepare the ink for ink jet recording increased in the content of the colorant contained, and the use of the ink can provide images having high print density.

When printing is made with the ink for ink jet recording using the microencapsulated pigment of the invention, using plain paper as the recording medium, blurring is hard to occur in printed images, and the print density of images is also high. The reason for this is considered to be largely due to that the hydrophilic groups existing on the surface of the microencapsulated pigment are regularly densely orientated toward the aqueous medium side. Usually, according to the conventional pigment ink (the pigment ink using pigment particles dispersed with a dispersant), an aqueous medium in the ink rapidly penetrates into plain paper, and pigment particles also move into the paper together with the aqueous medium, at the same time that ink droplets are ejected from an ink jet head and land on the plain paper. Accordingly, the pigment particles are difficult to be adsorbed on cellulose fiber on a print surface of the plain paper, so that the print density is low, and the color developability also become insufficient. In contrast, the ink for ink jet recording using the microencapsulated pigment of the invention is easily adsorbed or agglomerates by an interaction of the hydrophilic groups (particularly, the anionic groups) existing on the surface of the microencapsulated pigment with various metallic ions such as magnesium, calcium and aluminum usually contained in the plain paper, or cationic starch and a cationic polymer used together with a sizing agent in sizing treatment of the plain paper. Further, the ink is easily adsorbed on a surface of the cellulose fiber by an interaction of the plain paper with the cellulose fiber, so that when ink droplets are ejected from an ink jet head and land on the plain paper in an ink jet recording process, the microencapsulated pigment is easy to stay in the vicinity of a landing position. Accordingly, high image density is obtained, and blurring also becomes difficult to occur, resulting in improved print quality.

Furthermore, in the ink for ink jet recording of the invention, the pigment particles are encapsulated with the polymer, so that fixability to the recording medium is excellent, and abrasion resistance of recorded matter is also excellent.

Constituents used in the process for preparing a macroencapsulated pigment of the invention will be described in detail below.

In the invention, the following pigments can be used. In particular, “wet pigments” described later are preferably used in the invention.

The pigments preferably used in the invention include the following inorganic pigments and organic pigments.

The inorganic pigments include carbon blacks (C.I. Pigment Black 7) such as furnace black, lamp black, acetylene black and channel black, and an iron oxide pigment. As the organic pigments, there can be used an azo pigment (including azo lake, an insoluble azo pigment, a condensed azo pigment and a chelate azo pigment), a polycyclic pigment (for example, a phthalocyanine pigment, a perylene pigment, a perinone pigment, an anthraquinone pigment, a quinacridone pigment, a dioxane pigment, a thioindigo pigment, an isoindolinone pigment or a quinofranone pigment), a dye chelate (for example, a basic dye chelate or an acidic dye chelate), a nitro pigment, a nitroso pigment or aniline black.

More specifically, the inorganic pigments used for black include carbon blacks such as No. 2300, No. 900, MCF88, No. 33, No. 40, No. 45, No. 52, MA7, MA8, MA100 and No. 2200B manufactured by Mitsubishi Chemical Corporation, Raven 5750, Raven 5250, Raven 5000, Raven 3500, Raven 1255 and Raven 700 manufactured by Columbian Chemicals Company, Regal 400R, Regal 330R, Regal 660R, Mogul L, Monarch 700, Monarch 800, Monarch 880, Monarch 900, Monarch 1000, Monarch 1100, Monarch 1300 and Monarch 1400 manufactured by Cabot Corporation, and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A and Special Black 4 manufactured by Degussa Corporation.

Further, as the organic pigments for black, there can be used black organic pigments such as aniline black (C.I. Pigment Black 1).

Still further, the organic pigments for yellow inks include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 117, 120, 124, 128, 129, 133, 138, 139, 147, 151, 153, 154, 167, 172 and 180.

Yet still further, the organic pigments for magenta inks include C.I. Pigment Red 1, 2, 3, 4, 5, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224 and 245, and C.I. Pigment Violet 19, 23, 32, 33, 36, 38, 43 and 50.

Furthermore, the organic pigments for cyan inks include C.I. Pigment Blue 1, 2, 3, 15, 15:1, 15:2, 15:3, 15:34, 15:4, 16, 18, 22, 25, 60, 65 and 66, and C.I. Vat Blue 4 and 60.

In addition, as the organic pigments used for color inks other than magenta, cyan and yellow inks, there can be used C.I. Pigment Green 7, 10, 36 and 37, C.I. Pigment Brawn 3, 5, 25 and 26, and C.I. Pigment Orange 1, 2, 5, 7, 13, 14, 15, 16, 24, 34, 36, 38, 40, 43 and 63.

The “wet pigment” particularly preferably used in the invention is a pigment prepared in an aqueous phase and containing water in an amount of 40 to 80% by weight without drying (see JP 9-288378 A and JP 9-288379 A). Usually, agglomeration of the pigment particles proceeds with a decrease in water content, resulting in increased particle size. In general, a pigment is synthesized through various reactions, and finally dried to form a powder. The “wet pigment” used in the invention is a pigment containing water before drying. The wet pigments include various pigments having a water content of 40 to 80% by weight, for example, organic pigments such as a Monoazo Yellow pigment, a Disazo Yellow pigment, a carmine pigment, a rhodamine pigment, a quinacridone pigment, a phthalocyanine pigment, an anthraquinone pigment, a thioindigo pigment, a perinone pigment, a perylene pigment, a dioxane pigment, a quinophthalone pigment, an isoindolinone pigment and a benzimidazolone pigment, and carbon backs. In the invention, pigments having a water content of 40 to 80% by weight such as C.I. Pigment Red 48:1, C.I. Pigment Red 122, C.I. Pigment Yellow 17 and C.I. Pigment Blue 15:3 are particularly preferably used.

Specific examples of the processes for preparing the “wet pigments” are mentioned below.

(1) Azo Pigment

The azo pigment is obtained by the coupling reaction of a diazonium salt with a coupling component (such as a β-naphthol derivative showing keto-enol type tautomerism, an acetoacetic acid anilide derivative or a pyrazolone derivative). The coupling reaction is conducted in the presence of an alkali compound, and a solution after the reaction contains an azo pigment, a salt and water. The solution after the reaction and a concentrate thereof are usable as the wet pigment of this embodiment. Further, a product of the state after filtering the solution after the reaction, and washing the azo pigment in a wet state with water is also usable as the wet pigment of this embodiment.

(2) Phthalocyanine Pigment

The phthalocyanine pigment is obtained by conducting a pigmentation process such as a sulfuric acid process (a process for modifying the crystal form, the form of primary particles and the particle size distribution of a crude pigment to develop physical properties as a colorant) to a crude pigment (which is an acicular crystalline material, and cannot be used as it is) obtained by a phthalic anhydride process or a phthalodinitrile process. As the sulfuric acid processes, there have been known an acid pasting process and an acid slurry process.

In the acid pasting process, the crude pigment is dissolved in sulfuric acid having a concentration of 95% or more, and the resulting solution is poured into a large amount of water to precipitate the phthalocyanine pigment as fine particles. This solution after the reaction and a concentrate thereof are usable as the wet pigment of this embodiment. Further, a product of the state after filtering the solution after the reaction, and washing the azo pigment in a wet state with water is also usable as the wet pigment of this embodiment (a wet cake described in JP 9-279052 A, a pigment paste described in JP 2002-265812 A, or the like).

In the acid slurry process, the crude pigment is added to sulfuric acid having a concentration of 60 to 90%, followed by stirring to form crystals of phthalocyanine sulfate, which are poured into a large amount of water to precipitate the phthalocyanine pigment as fine particles. This solution after the reaction and a concentrate thereof are usable as the wet pigment of this embodiment. Further, a product of the state after filtering the solution after the reaction, and washing the phthalocyanine pigment in a wet state with water is also usable as the wet pigment of this embodiment (a pigment cake described in JP 8-217986 A, or the like).

(3) Polycyclic Pigment

(3-1) Quinacridone Pigment

As the preparation of the quinacridone pigment, there has been known a process for obtaining it by oxidation of dihydroquinacridone. In this case, the solution after the reaction and a concentrate thereof are usable as the wet pigment of this embodiment. Further, a product of the state after filtering the solution after the reaction, and washing the quinacridone pigment in a wet state with water is also usable as the wet pigment of this embodiment.

(3-2) Isoindolinone Pigment

The isoindolinone pigment is obtained by reacting 1 mole of an isoindolinone derivative with 2 moles of an aromatic diamine. The solution after the reaction and a concentrate thereof are usable as the wet pigment of this embodiment. Further, a product of the state after filtering the solution after the reaction, and washing the isoindolinone pigment in a wet state with water is also usable as the wet pigment of this embodiment.

(3-3) Perylene Pigment

The perylene pigment is obtained by a process comprising (i) reacting perylenetetracarboxylic acid diimide with sulfuric acid to prepare C.I. Pigment Red 224 (the first step) and then, reacting C.I. Pigment Red 224 with an aniline derivative (the second step), or (ii) reacting perylenetetracarboxylic acid diimide with an alkyl chloride.

In (i), the solution after the first step and a concentrate thereof are usable as the wet pigment (C.I. Pigment Red 224) of this embodiment. Further, a product of the state after filtering the solution after the reaction, and washing C.I. Pigment Red 224 in a wet state with water is also usable as the wet pigment of this embodiment. Furthermore, the solution of the second step and a concentrate thereof are usable as the wet pigment of this embodiment. Moreover, a product of the state after filtering the solution after the reaction, and washing the perylene pigment in a wet state with water is also usable as the wet pigment of this embodiment.

Further, pigment cakes before drying in processes for preparing disazo lake pigments described in JP 5-9399 A, JP 5-9400 A, JP 5-65426 A, JP 7-126545 A and JP 9-217017 A are usable as the wet pigments of this embodiment.

Furthermore, commercially available products usable as the wet pigments in this embodiment include an aqueous Lithol (registered trade mark)-Rubine-pigment suspension (C.I. 15850) and a Heliogen (registered trade mark)-blue-pigment cake (C.I. 74160).

In an aqueous dispersion of the microencapsulated pigment of the invention, the use of the wet pigment as described above allows the average particle size of pigment particles to be easily adjusted to 150 nm or less, thereby being able to impart excellent dispersibility, dispersion stability and ejection stability to the ink for ink jet recording using the microencapsulated pigment of the invention, and to increase the print density of images. When a general powder pigment is used, the particle size of the resulting microencapsulated pigment is liable to become large, which causes poor dispersibility, dispersion stability and ejection stability o the ink, and the print density of printed matter tends to decrease (in this specification, the description of the average particle size is described based on measured values by a laser light scattering process).

The microencapsulated pigment according to the embodiment of the invention can be suitably prepared by adding the polymerizable surfactant having a hydrophilic group, a hydrophobic group and a polymerizable group, the polymerization initiator and the aqueous medium to the wet pigment, and conducting emulsion polymerization, as described above.

The polymerizable surfactant used in the invention will be described below. The hydrophilic group of the polymerizable surfactant used in the invention is preferably an anionic group selected from the group consisting of a sulfonic acid group, a sulfinic acid group, a carboxyl group, a carbonyl group and salts of these groups, and/or a nonionic group selected from the group consisting of a hydroxyl group and an oxyethylene group, and the hydrophobic group is preferably selected from the group consisting of an alkyl group, an aryl group and a combination thereof. The polymerizable group is preferably an unsaturated hydrocarbon group, and more particularly, one selected from the group consisting of a vinyl group, an allyl group, an acryloyl group, a methacryloyl group, a propenyl group, a vinylidene group and a vinylene group. Of these, an acryloyl group and a methacryloyl group are particularly preferred.

Specific examples of the polymerizable surfactants used in the invention include anionic allyl derivatives as described in JP 49-46291 B, JP 1-24142 B and JP 62-104802 A, anionic propenyl derivatives as described in JP 62-221431 A, anionic acrylic acid derivatives as described in JP 62-34947 A and JP 55-11525 A, anionic itaconic acid derivatives as described in JP 46-34898 B and JP 51-30284 A, anionic maleic acid derivatives as described in JP 51-4157 B and JP 51-30284 A, nonionic allyl derivatives as described in JP 62-104802 A, nonionic propenyl derivatives as described in JP 62-100502 A, nonionic acrylic acid derivatives as described in JP 56-28208 A, nonionic itaconic acid derivatives as described in JP 59-12681 B, nonionic maleic acid derivatives as described in JP 59-74102 A, and cationic allyl derivatives as described in JP 4-65824 B.

The polymerizable surfactants used in the invention include, for example, an acrylic acid-modified polyoxyethylene alkyl ether, an acrylic acid-modified polyoxyethylene alkyl phenyl ether, an allylic acid-modified polyoxyethylene alkyl ether, an allylic acid-modified polyoxyethylene alkyl phenyl ether, an allylic acid-modified polyoxyethylene polystyrylphenyl ether, an acrylic acid-modified polyoxyethylene polystyrylphenyl ether, and polyoxyethylene-polyoxypropylene glycol monoacrylate.

The polymerizable surfactants preferably used in the invention include, for example, a compound represented by general formula (31): 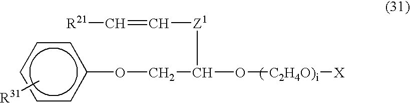
wherein R²¹ and R³¹ are each independently a hydrogen atom or a hydrocarbon group having 1 to 12 carbon atoms; Z¹ is a group represented by a carbon-carbon single bond or formula —CH₂—O—CH₂—; i is an integer of 2 to 20; and X is a hydrogen atom or formula —SO₃M¹, wherein M¹ is an alkali metal, an ammonium salt or an alkanolamine; and a compound represented by general formula (32): 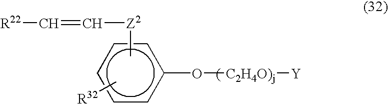
wherein R²² and R³² are each independently a hydrogen atom or a hydrocarbon group having 1 to 12 carbon atoms; Z² is a group represented by a carbon-carbon single bond or formula —CH₂—O—CH₂—; j is an integer of 2 to 20; and Y is a hydrogen atom or formula —SO₃M², wherein M² is an alkali metal, an ammonium salt or an alkanolamine.

The polymerizable surfactants represented by the above-mentioned formula (31) are described in JP 5-320276 A and JP 10-316909 A. It is possible to adjust the adsorbability onto the surface of the pigment particle and the hydrophilicity of the surface of the pigment particle by appropriately adjusting the kind of R²¹ and the value of i. Preferred specific examples of the polymerizable surfactants represented by formula (31) include compounds represented by the following formulas (31a) to (31d):

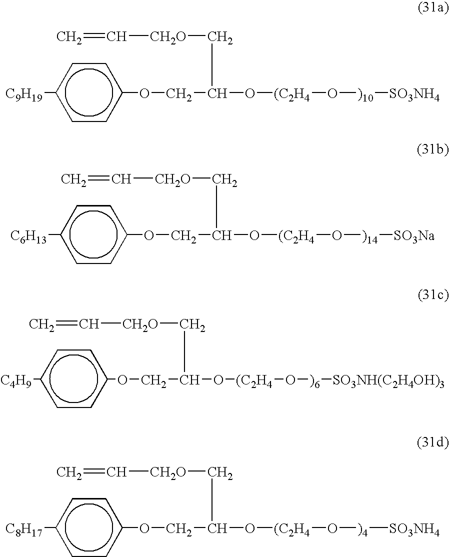

As the above-mentioned polymerizable surfactants, there can also be used commercially available products. Examples thereof include Aqualon HS series (Aqualon HS-05, HS-10, HS-20 and HS-1025), Aqualon RN series (RN-10, RN-20, RN-30, RN-50 and RN-2025) and New Frontier series (New Frontier N-177E and S-510), all of which are supplied from Daiichi Kogyo Yakuhin Co., Ltd.; and Adeka Reasoap SE series (SE-10N) and Adeka Reasoap NE series (NE-5, NE-10, NE-20, NE-30 and NE-40), all of which-are supplied from Asahi Denka Co., Ltd.

Further, the polymerizable surfactants preferably used in the invention include, for example, a compound represented by general formula (33): 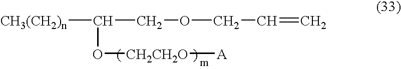
wherein n is 9 or 11; m is an integer of 2 to 30; and A is a group represented by a hydrogen atom or —SO₃M³, wherein M³ is an alkali metal, an ammonium salt or an alkanolamine.

It is possible to adjust the adsorbability onto the surface of the pigment particle and the hydrophilicity of the surface of the pigment particle by appropriately adjusting the values of n and m. Preferred specific examples of the polymerizable surfactants represented by formula (33) include the following compound: 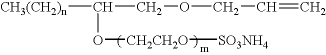
wherein n is 9 or 11; and m is 5 or 10.

As the above-mentioned polymerizable surfactants, there can also be used commercially available products. Examples thereof include Aqualon KH-05, Aqualon KH-10 and KH-20 supplied from Daiichi Kogyo Yakuhin Co., Ltd.

Further, a compound represented by the following formula (A) is also preferred as the polymerizable surfactant: 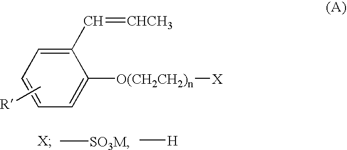
wherein R′ represents a hydrogen atom or a hydrocarbon group having 1 to 12 carbon atoms; n represents a number of 2 to 20; and M represents an alkali metal, an ammonium salt or an alkanolamine.

The polymerizable surfactants exemplified above can be used either alone or as a mixture of two or more thereof.

The amount (the amount added) of the above-mentioned polymerizable surfactant used in the invention is preferably equal to or more than the critical micelle concentration of the polymerizable surfactant used, and within the range of about 5 to 70% by weight, more preferably within the range of about 10 to 50% by weight, based on the pigment. Agglomeration of the microencapsulated pigment particles can be inhibited by adjusting the above-mentioned amount of the surfactant added to 5% by weight or more, and a pigment dispersion excellent in dispersibility is obtained. Further, the ink using the resulting pigment dispersion is also excellent in ejection stability from an ink jet recording head, and improved in adsorbability to paper fiber, resulting in excellent print density and color developability. Furthermore, the amount of the polymerizable surfactant which makes no contribution to a microencapsulation reaction of the pigment particles can be reduced to inhibit the generation of polymer particles having no pigment particles as a core substance by adjusting the above-mentioned amount of the surfactant added to 70% by weight or less.

Further, the microencapsulated pigment according to the embodiment of the invention can also be suitably produced by adding the wet pigment, the polymerizable surfactant having a hydrophilic group, a hydrophobic group and a polymerizable group, a comonomer copolymerizable with the polymerizable surfactant, a polymerization initiator and an aqueous medium, and conducting emulsion polymerization. When the ink using the microencapsulated pigment of the invention is printed on a recording medium by an ink jet recording process using the comonomer appropriately selected, the fixability of the microencapsulated pigment or a colorant to the recording medium and the abrasion resistance can be improved. The use of the comonomer appropriately selected can control the solvent resistance of the microencapsulated pigment in the ink, and it is also easy to improve the storage stability of the ink. In particular, the fixability of the microencapsulated pigment to the recording medium and the abrasion resistance can be obtained by adjusting the glass transition temperature (Tg) of a copolymer covering the pigment particles of the microencapsulated pigment according to the invention within the range of −20° C. to 30° C. When the glass transition temperature exceeds 30° C., the fixability and abrasion resistance decrease. When it is lower than −20° C., the solvent resistance tends to decrease. The glass transition temperature of this copolymer can be adjusted within the range of −20° C. to 30° C. by appropriately selecting a monomer described later.

The above-mentioned comonomers used in the invention include a hydrophilic monomer and a hydrophobic monomer. The hydrophobic monomer used in the invention is one having at least a hydrophobic group and a polymerizable group in its structure, and the hydrophobic group is suitably selected from the group consisting of an aliphatic hydrocarbon group, an alicyclic hydrocarbon group and an aromatic hydrocarbon group. Further, the hydrophilic monomer used in the invention is one having at least a hydrophilic group and a polymerizable group in its structure, and the hydrophilic group is suitably selected from the group consisting of a sulfonic acid group, a sulfinic acid group, a carboxyl group, a carbonyl group, salts of these groups, a hydroxyl group, an oxyethylene group, an amido group and an amino group.

The polymerizable group as used herein is a radically polymerizable unsaturated hydrocarbon group, in either case of a hydrophilic monomer or a hydrophobic monomer, and preferably selected from the group consisting of a vinyl group, an allyl group, an acryloyl group, a methacryloyl group, a propenyl group, a vinylidene group and a vinylene group.

In the hydrophobic monomers used in the invention, the aliphatic hydrocarbon groups include a methyl group, an ethyl group and a propyl group, the alicyclic hydrocarbon groups include a cyclohexyl group, a dicyclopentenyl group and isobornyl group, and the aromatic hydrocarbon groups include a benzyl group, a phenyl group and a naphthyl group.

Further, specific examples of the hydrophobic monomers include styrene derivatives such as styrene, α-methylstyrene, o-methylstyrene, m-methylstyrene, p-methylstyrene, dimethylstyrene, p-tert-butylstyrene, chlorostyrene, dichlorostyrene, bromostyrene and p-chloromethylstyrene; monofunctional acrylic esters such as methyl acrylate, ethyl acrylate, isopropyl acrylate, n-propyl acrylate, n-butyl acrylate, t-butyl acrylate, isobutyl acrylate, n-octyl acrylate, lauryl acrylate, dodecyl acrylate, stearyl acrylate, tridecyl acrylate, isodecyl acrylate, isooctyl acrylate, isomyristyl acrylate, isostearyl acrylate, isoamyl acrylate, 2-ethylhexyl acrylate, benzyl acrylate, phenyl acrylate, phenoxyethyl acrylate, phenoxydiethylene glycol acrylate, phenoxypolyethylene glycol acrylate, ethylene oxide-modified nonylphenol acrylate, cyclohexyl acrylate, dicyclopentanyl acrylate, dicyclopentenyl acrylate, dicyclopentenyloxyethyl acrylate, isobornyl acrylate and tetrahydrofurfuryl acrylate; monofunctional methacrylic esters such as methyl methacrylate, ethyl methacrylate, isopropyl methacrylate, n-propyl methacrylate, n-butyl methacrylate, t-butyl methacrylate, isobutyl methacrylate, n-octyl methacrylate, lauryl methacrylate, dodecyl methacrylate, stearyl methacrylate, tridecyl methacrylate, isodecyl methacrylate, isooctyl methacrylate, isomyristyl methacrylate, isostearyl methacrylate, isoamyl methacrylate, 2-ethylhexyl methacrylate, benzyl meth-acrylate, phenyl methacrylate, phenoxyethyl methacrylate, phenoxydiethylene glycol methacrylate, phenoxypolyethylene glycol methacrylate, ethylene oxide-modified nonylphenol methacrylate, cyclohexyl methacrylate, dicyclopentanyl methacrylate, dicyclopentenyl methacrylate, dicyclopentenyloxyethyl methacrylate, isobornyl methacrylate and tetrahydrofurfuryl methacrylate; addition reaction products of oil fatty acids and oxirane structure-containing (meth)acrylic ester monomers such as an addition reaction product of stearic acid and glycidyl methacrylate; addition reaction products of oxirane compounds containing an alkyl group having 3 or more carbon atoms and (meth)acrylic acid; allyl compounds such as allylbenzene, allyl-3-cyclohexane proponate, 1-allyl-3,4-dimethoxybenzene, allyl phenoxyacetate, allyl phenylacetate and allylcyclohexane; esters of fumaric acid, maleic acid and itaconic acid; and radically polymerizable group-containing monomers such as an N-substituted maleimide and a cyclic olefin.

Further, the hydrophilic monomer used in the invention is one having at least a hydrophilic group and a polymerizable group in its structure, and the hydrophilic group is suitably selected from the group consisting of a sulfonic acid group, a sulfinic acid group, a carboxyl group, a carbonyl group, salts of these groups, a hydroxyl group, an oxyethylene group, an amido group and an amino group. In particular, a sulfonic acid group, a sulfinic acid group, a carboxyl group, a carbonyl group and salts of these groups easily interact with various metal ions such as magnesium, calcium and aluminum, cationic starch and cationic polymers which are usually contained in plain paper, and also easily interact with a surface of cellulose fiber constituting the plain paper. Accordingly, when the plain paper is printed with the ink for ink jet recording using the microencapsulated pigment produced by use of the above-mentioned hydrophilic monomer, by the ink jet recording process, the above-mentioned microencapsulated pigment is easy to stay in the vicinity of a landing position. Accordingly, high image density is obtained more reliably, and blurring can also be inhibited from occurring in images.

From such a viewpoint, preferred specific examples of the hydrophilic monomers used in the invention include, for example, acrylic acid, methacrylic acid, propylacrylic acid, isopropylacrylic acid, 2-acryloyloxyethylsuccinic acid, 2-acryloyloxyethylphthalic acid, 2-methacryloyloxyethylsuccinic acid, 2-methacryloyloxyethylphthalic acid, itaconic acid, fumaric acid and maleic acid. Of these, acrylic acid and methacrylic acid are preferred. Further, the sulfonic acid group-containing monomers include, for example, 4-styrenesulfonic acid and a salt thereof, vinylsulfonic acid and a salt thereof, sulfoethyl acrylate and a salt thereof, sulfoethyl methacrylate and a salt thereof, a sulfoalkyl acrylate and a salt thereof, a sulfoalkyl methacrylate and a salt thereof, sulfopropyl acrylate and a salt thereof, sulfopropyl methacrylate and a salt thereof, a sulfoaryl acrylate and a salt thereof, a sulfoaryl methacrylate and a salt thereof, butylacrylamidosulfonic acid and a salt thereof, and 2-acrylamido-2-methylpropanesulfonic acid and a salt thereof. Still further, phosphone group-containing monomers include a phosphoric acid group-containing (meth)acrylate such as phosphoethyl methacrylate. Yet still further, the hydroxyl group-containing monomers include, for example, 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, polyethylene glycol 400 monoacrylate, polyethylene glycol 400 monomethacrylate, polyethylene glycol monomethacrylate, N-hydroxyethyl acrylate, N-hydroxyethyl meth-acrylate, dipropylene glycol acrylate and 2-hydroxy-3-phenoxypropyl acrylate. Furthermore, the amido group-containing monomers include acrylamide, methacrylamide, acrylaminoethylamide, acrylmethylaminoethylamide, acrylmethylaminopropylamide, acrylethylaminoethylamide, acrylethylaminopropylamide, acrylaminopropylamide, methacrylaminoethylamide, methacrylmethylaminoethylamide, methacrylmethylaminopropylamide, methacrylethylaminoethylamide, methacrylethylaminopropylamide, methacrylaminopropylamide and vinylpyrrolidone. Moreover, they include ethyldiethylene glycol acrylate, ethyldiethylene glycol methacrylate, methoxypolyethylene glycol acrylate, methoxyethylene glycol methacrylate, methoxytriethylene glycol methacrylate and N-vinyl-2-pyrrolidone.

Further, a crosslinking monomer can also be used in the invention. The crosslinking monomer usable in the invention is a compound having two or more of unsaturated hydrocarbon groups of at least one kind selected from the group consisting of a vinyl group, an allyl group, an acryloyl group, a methacryloyl group, a propenyl group, a vinylidene group and a vinylene group. Examples thereof include ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxyneopentyl glycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)phenyl]propane, 2,2-bis[4-(acryloxyethoxy-diethoxy)phenyl]propane, 2,2-bis[4-(acryloxyethoxypoly-ethoxy)phenyl]propane, hydroxypivaric acid neopentyl glycol diacrylate, 1,4-butanediol diacrylate, dicyclopentanyl diacrylate, dipentaerythritol hexaacrylate, dipentaerythritol monohydroxypentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol di-methacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxypropane, 2,2-bis[4-(methacryloxy)phenyl]propane, 2,2-bis[4-(methacryloxyethoxy)phenyl]propane, 2,2-bis[4-(methacryloxyethoxydiethoxy)phenyl]propane, 2,2-bis[4-(methacryloxyethoxypolyethoxy)phenyl]propane, tetrabromobisphenol A dimethacrylate, dicyclopentanyl dimethacrylate, dipentaerythritol hexamethacrylate, glycerol dimethacrylate, hydroxypivaric acid neopentyl glycol dimethacrylate, dipentaerythritol monohydroxy-pentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl) isocyanurate, allyl methacrylate, divinylbenzene, diallyl phthalate, diallyl terephthalate, diallyl isophthalate and diethylene glycol bisallylcarbonate.

When the above-mentioned crosslinking monomer is used, a capsule wall material for the microencapsulated pigment of the invention becomes a polymer having a crosslinked structure to form a layer particularly excellent in long-term storage stability in aqueous media comprising various water-soluble organic solvents and water. Although the reason for this is not clear, it is conceivable as one reason for this that the solvent resistance is improved due to the polymer having the crosslinked structure.

The amount (amount added) of the above-mentioned monomer used in the invention is preferably within the range of 0.0001 to 0.05 time the molarity of the above-mentioned hydrophobic monomer, and more preferably in the range of 0.001 to 0.01 time the molarity thereof. Exceeding 0.05 time the molarity of the hydrophobic monomer unfavorably results in the occurrence of a deterioration in fixability or abrasion resistance, and an increase in particle size in some cases. It is preferred that the amount of the above-mentioned crosslinking monomer added is appropriately decided within the above-mentioned range, considering the solvent resistance, fixability and abrasion resistance.

The polymer constituting the capsule wall material for the microencapsulated pigment particles of the invention is obtained by polymerizing the polymerizable surfactant, or the polymerizable surfactant and the comonomer, as described above. This polymerization reaction can be conducted using a known polymerization initiator, and particularly, the use of a radical polymerization initiator is preferred. As the polymerization initiator, preferred is a water-soluble polymerization initiator, which includes potassium persulfate, ammonium persulfate, sodium persulfate, 2,2-azobis-(2-methylpropionamidine) dihydrochloride and 4,4-azobis-(4-cyanovaleric acid).

The process for preparing the microencapsulated pigment of the invention will be described below.

In the invention, the wet pigment is previously dispersed in a general dispersing device such as a ball mill, a roll mill, an Eiger mill or a jet mill using the above-mentioned polymerizable surfactant and aqueous medium, and the resulting product is put into a reaction vessel equipped with a ultrasonic generator, a stirrer, a reflux condenser, a dropping funnel, and a temperature controller. The above-mentioned comonomer is added thereto as needed, followed by ultrasonication for a specified period of time. Then, the system is elevated to a specified temperature, and an aqueous solution of the above-mentioned water-soluble polymerization initiator in pure water is added dropwise to conduct a polymerization reaction, thereby being able to suitably obtain the microencapsulated pigment of the invention. After the termination of the polymerization, impurities such as unreacted materials are removed by centrifugal filtration and/or ultrafiltration, and the pH is preferably adjusted to the range of 7.0 to 9.0. Coarse particles are preferably removed by further filtration. The aqueous medium as used herein means a solvent containing water as a main component, and may contain a water-soluble organic solvent such as a glycerol or a glycol as an optional component, in addition to water. Further, the polymerization temperature is preferably within the range of 60 to 90° C.

In the microencapsulate pigment of the invention obtained as described above, it is conceivable that the pigment particles are completely encapsulated with the polymer layer without defects, and that the hydrophilic groups are regularly orientated toward the aqueous medium in the uppermost layer of the encapsulating polymer (see FIG. 2). Accordingly, the pigment has high dispersion stability to the aqueous medium.

Although the microencapsulated pigment according to the embodiment of the invention is described above, the particle size (average particle size) of the microencapsulated pigment is preferably 400 nm or less, more preferably 300 nm or less, and particularly preferably from 50 to 200 nm.

Aqueous Dispersion

The aqueous dispersion according to an embodiment of the invention contains the microencapsulated pigment according to the embodiment of the invention, and as such an aqueous dispersion, there can be suitably exemplified the solution after emulsion polymerization described in the above-mentioned embodiment. Other compounding components for obtaining the ink for ink jet recording are further normally added to the aqueous dispersion, thereby being able to prepare the ink for ink jet recording according to an embodiment of the invention. In the ink for ink jet recording according to an embodiment of the invention, the aqueous dispersion containing the microencapsulated pigment is preferably purified. This aqueous dispersion sometimes contains unreacted materials derived from the monomers used, that is, unreacted materials derived from the above-mentioned polymerizable surfactant and the comonomer copolymerizable with the above-mentioned polymerizable surfactant, in addition to the encapsulated pigment, and the concentration of the unreacted materials contained in the ink for ink jet recording can be reduced.

In the invention, impurities such as the unreacted monomers contained in the above-mentioned aqueous dispersion are thus removed for purification to reduce the concentration of the unreacted materials derived from the components constituting the encapsulating polymer of the above-mentioned microencapsulated pigment, thereby being able to decrease the viscosity of the ink for ink jet recording. This can increase the content of a colorant in the ink. Accordingly, the use of the ink for ink jet recording using the microencapsulated pigment of the invention on plain paper can more increase the print density, provide good chroma saturation, and inhibit the occurrence of blurring in images. Further, when it is used on exclusive media for ink jet recording, particularly on glossy media for ink jet, good glossiness is obtained. In particular, when the glass transition temperature of the encapsulating polymer of the above-mentioned microencapsulated pigment is 30° C. or lower, preferably 15° C. or lower, and more preferably 10° C. or lower, images having more excellent glossiness, high chroma saturation and excellent sharpness are obtained.

The amount of the unreacted materials contained in all components other than solid matter of the aqueous dispersion containing the microencapsulated pigment of the invention is preferably 50,000 ppm or less, and more preferably 10,000 ppm or less. The unreacted material as used herein means: those which did not contributed to the formation of the encapsulating polymer of the microencapsulated pigment, among the polymerizable surfactant and the comonomers including the hydrophobic monomer and hydrophilic monomer copolymerizable with the above-mentioned polymerizable surfactant; and a water-soluble oligomer and a water-soluble polymer existing in water as by-products without contributing to the formation of the polymer serving as the wall material for the microencapsulated pigment.

Referring to the concentration of the unreacted materials before the purification treatment, it is usually preferred that the concentration of the above-mentioned polymerizable surfactant is within the range of 5 to 40% by weight based on the charged amount. Further, when the above-mentioned polymerizable surfactant and the comonomer copolymerizable with the above-mentioned polymerizable surfactant are emulsion polymerized, it is preferred that the concentration of the above-mentioned polymerizable surfactant and the above-mentioned comonomer are each within the range of 5 to 40% by weight.

As a method for purifying the aqueous dispersion containing the microencapsulated pigment, there can be used centrifugal separation, ultrafiltration or the like.

In the invention, the concentration of the above-mentioned polymerizable surfactant and comonomer contained in the aqueous dispersion can be measured by the following first method or second method:

First Method

That is, the spectral characteristics of the polymerizable surfactant and comonomer (hydrophilic monomer) dissolved in ion exchanged water are previously measured with a spectrophotometer, and a calibration curve is determined from the amount of each material dissolved in ion exchanged water and the absorbance at a characteristic absorption wavelength. Then, the resulting aqueous dispersion of the microencapsulated pigment is centrifuged at 20,000 revolutions for 30 minutes with a centrifugal separator, and the resulting supernatant is diluted to a specified dilution (for example, a 100-fold dilution). The absorbance of this diluted solution at 200 to 400 nm was measured with a spectrophotometer, and the amount of each material in the supernatant is determined from the above-mentioned calibration curve.

Further, as to the hydrophobic monomer, the spectral characteristics of the hydrophobic monomer dissolved in an organic solvent such as n-hexane is previously measured with a spectrophotometer to determine a calibration curve from the amount dissolved in the organic solvent such as n-hexane and the absorbance at a characteristic absorption wavelength. Then, the resulting aqueous dispersion of the microencapsulated pigment is mixed with the organic solvent such as n-hexane, and an organic solvent phase is collected and diluted to a specified dilution. The absorbance of this diluted solution at 200 to 400 nm was measured with a spectrophotometer, and the amount of the hydrophobic monomer extracted in the organic solvent such as n-hexane is determined from the above-mentioned calibration curve.

Second Method

The polymerizable surfactant and comonomer (hydrophilic monomer) dissolved in ion exchanged water are previously subjected to liquid chromatography, and a calibration curve is determined from the amount of each material dissolved in ion exchanged water and the retention time. Then, the resulting dispersion of the microencapsulated pigment is centrifuged at 20,000 revolutions for 30 minutes with a centrifugal separator, and the resulting supernatant is separated by liquid chromatography. The amounts of the polymerizable surfactant and hydrophilic monomer dissolved in the supernatant are determined from the retention amounts of the polymerizable surfactant and hydrophilic monomer at each retention time, and the above-mentioned calibration curve.

As for the hydrophobic monomer, the hydrophobic monomer dissolved in the organic solvent such as n-hexane is previously subjected to liquid chromatography to determine a calibration curve from the amount dissolved in the organic solvent such as n-hexane and the retention time. Then, the resulting aqueous dispersion of the microencapsulated pigment is mixed with the organic solvent such as n-hexane. An organic solvent phase is collected and separated by liquid chromatography. The amount of the hydrophobic monomer extracted in the organic solvent such as n-hexane is determined from the retention amount of the hydrophobic monomer at retention time, and the above-mentioned calibration curve.

Ink for Ink Jet Recording

The ink for ink jet recording according to an embodiment of the invention contains the aqueous dispersion, as described above.

Further, the ink for ink jet recording according to another embodiment of the invention contains at least the microencapsulated pigment according to the embodiment of the invention and water. The content of the microencapsulated pigment is preferably from 1 to 20% by weight, and more preferably from 3 to 15% by weight, based on the total weight of the ink for ink jet recording. In particular, in order to obtain high print density and high color developability, it is preferably from 5 to 15% by weight.

A solvent for the ink for ink jet recording according to the embodiment of the invention preferably contains water and a water-soluble organic solvent as basic solvents, and can contain any other components as needed.

The above-mentioned water-soluble organic solvents used in the ink of the invention include an alkyl alcohol having 1 to 4 carbon atoms such as ethanol, methanol, butanol, propanol or isopropanol. One or two or more of solvents selected therefrom can be used in the ink of the invention.

Further, in order to impart water retentivity and wetting properties to the ink for ink jet recording, a wetting agent comprising a high boiling water-soluble organic solvent is preferably added. Such a high boiling water-soluble organic solvent is a high boiling water-soluble organic solvent having a boiling point of 180° C. or higher.

Specific examples of the water-soluble organic solvents having a boiling point of 180° C. or higher, which can be used in the invention, include ethylene glycol, propylene glycol, diethylene glycol, pentamethylene glycol, trimethylene glycol, 2-butene-1,4-diol, 2-ethyl-1,3-hexanediol, 2-methyl-2,4-pentanediol, tripropylene glycol monomethyl ether, dipropylene glycol monoethyl glycol, tetraethylene glycol, triethylene glycol, tripropylene glycol, polyethylene glycol having a molecular weight of 2,000 or less, 1,3-propylene glycol, isopropylene glycol, isobutylene glycol, glycerol, mesoerythritol and pentaerythritol. It is more preferred that the high boiling water-soluble organic solvent used in the invention has a boiling point of 200° C. or higher. One or two or more of them can be used in the ink of the invention. Addition of the high boiling water-soluble organic solvent to the ink can provide the ink for ink jet recording which retains flowability and re-dispersibility for a long period of time even when it is allowed to stand in an open state (a state in which the ink is in contact with air at room temperature). Further, such an ink is hard to clog ink jet nozzles during printing using an ink jet printer or on restarting after the interruption of printing, so that the ink having high ejection stability from the ink jet nozzles is obtained.

The total content of the water-soluble organic solvents including the high boiling water-soluble organic solvent is preferably from about 10 to about 50% by weight, and more preferably from 10 to 30% by weight, based on the total weight of the ink for ink jet recording. At least one polar solvent selected from the group consisting of 2-pyrrolidone, N-methylpyrrolidone, ε-caprolactam, dimethyl sulfoxide, sulforane, morpholine, N-ethylmorpholine and 1,3-dimethyl-2-imidazolidinone can be added to the ink. Addition of the polar solvent can provide the effect of improving the dispersibility of the encapsulated pigment particles in the ink to improve the ejection stability of the ink.

The content of these polar solvents is preferably from 0.1 to 20% by weight, and more preferably from 1 to 10% by weight, based on the total weight of the ink for ink jet recording.

In order to accelerate penetration of the aqueous medium into the recording medium, it is preferred that the ink for ink jet recording of the invention further contains a penetrant. Prompt penetration of the aqueous medium into the recording medium can provide recorded matter having images with less blurring. As such penetrants, there are preferably used an alkyl ether of a polyhydric alcohol (also referred to as a glycol ether) and a 1,2-alkyldiol. The alkyl ethers of polyhydric alcohols include, for example, ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-i-propyl ether, diethylene glycol mono-i-propyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-1-propyl ether, dipropylene glycol monomethyl ether, dipropylene glycol monoethyl ether, dipropylene glycol mono-n-propyl ether, dipropylene glycol mono-1-propyl ether, propylene glycol mono-n-butyl ether and dipropylene glycol mono-n-butyl ether. The 1,2-alkyldiols include, for example, 1,2-pentanediol and 1,2-hexanediol. Besides, the penetrants include diols of straight-chain hydrocarbons such as 1,3-propanediol, 1,4-butanediol, 1,5-pentanediol, 1,6-hexanediol, 1,7-heptanediol and 1,8-octanediol. The penetrant can be appropriately selected therefrom and used in the ink of the invention.

In particular, in an embodiment of the invention, it is preferred that at least one selected from propylene glycol monobutyl ether, dipropylene glycol monobutyl ether, diethylene glycol monobutyl ether, triethylene glycol monobutyl ether, 1,2-pentanediol and 1,2-hexanediol is used as the penetrant. The total content of these penetrants is preferably from 1 to 20% by weight, and more preferably from 1 to 10% by weight, based on the total weight of the ink for ink jet recording. When the content of the penetrant is adjusted to 1% by weight or more, the effect of improving the penetrability of the ink into the recording medium is obtained. Further, adjustment to 20% by weight or less can prevent the occurrence of blurring in images printed using this ink, and can prevent an excessive increase in the viscosity of the ink. In particular, when the 1,2-alkyldiol such as 1,2-pentanediol or 1,2-hexanediol is used in the ink, drying properties of the ink after printing are improved, and blurring in images can be decreased. Dramatically improved is.

When the ink of the invention contains glycerol, clogging of ink jet nozzles at the time when the ink is used for ink jet recording becomes difficult to occur, and further, storage stability of the ink itself can also be improved.

Further, when the glycol ether is used in the ink of the invention, an acetylene glycol-based surfactant described later is preferably used in combination with the glycol ether.

Furthermore, it is preferred that the ink for ink jet recording according to an embodiment of the invention contains a surfactant, particularly an anionic surfactant and/or an nonionic surfactant. Specific examples of the anionic surfactants include an alkanesulfonate, an α-olefinsulfonate, an alkylbenzenesulfonate, an alkylnaphthalenesulfonic acid, an acylmethyltaurinic acid, a dialkylsulfosuccinic acid, an alkylsulfuric ester salt, a sulfated oil, a sulfated olefin, a polyoxyethylene alkyl ether sulfuric ester salt, a fatty acid salt, an alkylsarcosine salt, an alkylphosphoric ester salt, a polyoxyethylene alkyl ether phosphoric ester salt and a monoglyceride phosphoric ester salt. Further, specific examples of the nonionic surfactants include a polyoxyethylene alkyl ether, a polyoxyethylene alkyl phenyl ether, a polyoxyethylene alkyl ester, a polyoxyethylene alkylamide, a glycerol alkyl ester, a sorbitan alkyl ester, a sugar alkyl ester, a polyhydric alcohol alkyl ether and an alkanolamine fatty acid amide.

More specifically, the anionic surfactants include ether surfactants such as sodium dodecylbenzenesulfonate, sodium laurate and an ammonium salt of a polyoxyethylene alkyl ether sulfate. Specific examples of the nonionic surfactants include polyoxyethylene nonyl phenyl ether, polyoxyethylene octyl phenyl ether, polyoxyethylene dodecyl phenyl ether, a polyoxyethylene alkyl allyl ether, polyoxyethylene oleyl ether, polyoxyethylene lauryl ether, a polyoxyethylene alkyl ether and a polyoxyalkylene alkyl ether, and ester surfactants such as polyoxyethylene oleic acid, polyoxyethylene oleic acid ester, polyoxyethylene distearic acid ester, sorbitan laurate, sorbitan monostearate, sorbitan monooleate, sorbitan sesquioleate, polyoxyethylene monooleate and polyoxyethylene stearate.

In particular, it is desirable that the ink for ink jet recording according to an embodiment of the invention contains an acetylene glycol-based surfactant and/or an acetylene alcohol-based surfactant. The aqueous medium contained in the ink becomes easy to penetrate into the recording medium thereby, so that images having little blurring can be printed on various recording media.

Preferred specific examples of the acetylene glycol-based surfactants used in the invention include a compound represented by the following formula (6): 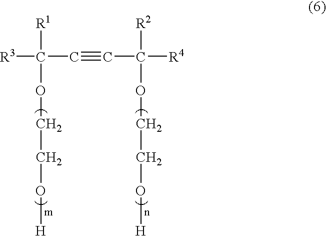
wherein m and n are each a number satisfying 0≦m+n≦50; and R1, R², R³ and R⁴ are each independently an alkyl group (preferably, an alkyl group having 6 or less carbon atoms).

Of the compounds represented by the above formula (6), particularly preferred are 2,4,7,9-tetramethyl-5-decyne-4,7-diol, 3,6-dimethyl-4-octyne-3,6-diol and 3,5-dimethyl-1-hexyne-3-ol. As the compounds represented by the above formula (6), it is also possible to utilize commercial products commercially available as the acetylene glycol-based surfactants. Specific examples thereof include Surfynol 104, 82, 465, 485 and TG (all are available from Air Products and Chemicals, Inc.), and Olfine STG and Olfine E1010 (trade names, manufactured by Nissin Chemical Industry Co., Ltd.).

The acetylene alcohol-based surfactants include Surfynol 61 (available from Air Products and Chemicals, Inc.).

These acetylene glycol-based surfactants and/or acetylene alcohol-based surfactants are used preferably in an amount ranging from 0.01 to 10% by weight, and more preferably in an amount ranging from 0.1 to 5% by weight, based on the total weight of the ink for ink jet recording.

Further, the ink for ink jet recording of the invention can contain a pH adjuster. The pH of the ink is adjusted preferably to 7 to 9, and more preferably to 7.5 to 8.5.

Preferred specific examples of the pH adjusters include potassium metal compounds such as sodium hydroxide, potassium hydroxide, lithium hydroxide, sodium carbonate, sodium hydrogencarbonate, potassium carbonate, lithium carbonate, sodium phosphate, potassium phosphate, lithium phosphate, potassium dihydrogenphosphate, dipotassium hydrogenphosphate, sodium oxalate, potassium oxalate, lithium oxalate, sodium borate, sodium tetraborate, potassium hydrogenphthalate and potassium hydrogentartrate; ammonia; and amines such as methylamine, ethylamine, diethylamine, trimethylamine, triethylamine, tris(hydroxymethyl)aminomethane hydrochloride, triethanolamine, diethanolamine, diethylethanolamine, triisopropenolamine, butyldiethanolamine, morpholine and propanolamine.

Of these, when an alkali hydroxide compound or an amine alcohol added to the ink, the dispersion stability of the microencapsulated pigment particles of the invention in the ink can be improved.

When the alkali hydroxide compound is added to the ink of the invention, the amount thereof added is preferably from 0.01 to 5% by weight, and more preferably from 0.05 to 3% by weight, based on the total weight of the ink.

When the amine alcohol is added to the ink, the amount thereof added is preferably from 0.1 to 10% by weight, and more preferably from 0.5 to 5% by weight, based on the total weight of the ink.

Further, for the purpose of mildewproofing, antisepsis or rust prevention, at least one compound selected from benzoic acid, dichlorophene, hexachlorophene, sorbic acid, a p-hydroxybenzoic ester, ethylenediaminetetraacetic acid (EDTA), sodium dehydroacetate, 1,2-benthiazolin-3-on (product name: Proxel XL manufactured by Avecia) and 4,4-dimethyloxazolidine can be added to the ink for ink jet recording.

Furthermore, for the purpose of preventing nozzles of a recording head from being dried, at least one selected from the group consisting of urea, thiourea and ethylene urea can also be added to the ink for ink jet recording.

A particularly preferred embodiment of the ink for ink jet recording of the invention is an ink containing at least
(1) the above-mentioned microencapsulated pigment,
(2) at least one compound (penetrant) selected from the group consisting of diethylene glycol monobutyl ether, triethylene glycol monobutyl ether and an 1,2-alkyldiol having 4 to 10 carbon atoms,
(3) glycerol, and
(4) water.

Another particularly preferred embodiment of the ink for ink jet recording of the invention contains at least
(1) the microencapsulated pigment according to the embodiment of the invention,
(2) at least one compound (penetrant) selected from the group consisting of diethylene glycol monobutyl ether, triethylene glycol monobutyl ether and an 1,2-alkyldiol having 4 to 10 carbon atoms,
(3) the acetylene glycol-based surfactant and/or the acetylene alcohol-based surfactant,
(4) glycerol, and
(5) water.

In each embodiment described above, the amount of diethylene glycol monobutyl ether and/or triethylene glycol monobutyl ether of (2) as the penetrant added is preferably 10% by weight or less, and more preferably from 0.5 to 5% by weight, based on the total weight of the ink. Addition of diethylene glycol monobutyl ether and/or triethylene glycol monobutyl ether can improve penetrability of the ink into the recording medium, and are available for improving print quality. Further, diethylene glycol monobutyl ether and/or triethylene glycol monobutyl ether also have the effect of improving solubility of the acetylene glycol-based surfactant.

In each embodiment described above, the amount added at the time when the 1,2-alkyldiol having 4 to 10 carbon atoms of (2) as the penetrant is added to the ink is 15% by weight or less based on the total weight of the ink. When the 1,2-alkyldiol having 3 or less carbon atoms is used, sufficient penetrability into the recording medium is not obtained. The 1,2-alkyldiol having 16 or more carbon atoms is unfavorable because it becomes difficult to dissolve in water. When the amount of the 1,2-alkyldiol in the ink exceeds 15% by weight, the viscosity of the ink unfavorably tends to increase. Specifically, 1,2-pentanediol or 1,2-hexanediol is preferably used as the 1,2-alkyldiol. Either one can be used alone, or both can be used in combination. 1,2-Pentanediol is preferably added in an amount ranging from 3 to 15% by weight based on the total weight of the ink. Addition of 1,2-pentanediol to the ink in an amount of 3% by weight or more provides the ink having good penetrability. 1,2-Hexanediol is preferably added in an amount ranging from 0.5 to 10% by weight based on the total weight of the ink, and the ink having good penetrability is obtained within the above-mentioned range.

Further, when the ink of each embodiment described above is used in the ink jet recording process, in order to make it difficult to generate the clogging of the ink jet nozzles (improvement in clogging reliability), and in order to inhibit the occurrence of white blanks (fine places having no ink on the recording medium) in an image region of printed matter obtained by the ink jet recording process using the ink of each embodiment described above, a solid wetting agent is preferably added in an amount of 3 to 20% by weight based on the total weight of the ink. Addition of the solid wetting agent is not limited to each embodiment described above, and it can be added to the ink using the microencapsulated pigment of the invention.

The above-mentioned solid wetting agent means a water-soluble substance which is solid at ordinary temperature (25° C.) and has a water-retaining function. Preferred examples of the solid wetting agents include a saccharide, a sugar alcohol, a hyaluronate, trimethylolpropane and 1,2,6-hexanetriol. Examples of the saccharides include a monosaccharide, a disaccharide, an oligosaccharide (including a trisaccharide and a tetrasaccharide) and a polysaccharide. Preferred examples thereof include glucose, mannose, fructose, ribose, xylose, arabinose, galactose, aldonic acid, glucitol, sorbit, maltose, cellobiose, lactose, sucrose, trehalose and maltotriose. The term “polysaccharide” as used herein means a saccharide in its broad sense, and is used in the sense that it includes substances widely occurring in nature such as alginic acid, α-cyclodextrin and cellulose. Further, derivatives of these saccharides include a reduced sugar of the above-mentioned saccharide (for example, a sugar alcohol represented by the general formula HOCH₂(CHOH)ₙCH₂OH (wherein n represents an integer of 2 to 5), an oxidized sugar (for example, an aldonic acid or a uronic acid), an amino acid and a thiosugar. In particular, a sugar alcohol is preferred, and specific examples thereof include maltitol, sorbitol and xylitol. As the hyaluronate, there can be used a product commercially available as a 1% aqueous solution of sodium hyaluronate (molecular weight: 350,000). Particularly preferred examples of the solid wetting agents are trimethylolpropane, 1,2,6-hexanetriol, a saccharide and a sugar alcohol. One or two or more solid wetting agents can be added to the ink of the invention.

The use of the solid wetting agent in the ink can restrain the evaporation of water of the ink by its water retaining function, so that the viscosity of the ink does not increase in flow paths of the ink of an ink jet printer or in the vicinities of ink jet nozzles, and the film formation caused by the evaporation of water of the ink also becomes difficult to occur, which causes difficulty in clogging the nozzles. Further, the above-mentioned solid wetting agent is chemically stable, so that it does not decompose in the ink, and the quality of the ink can be maintained for a long period of time. Furthermore, even when the above-mentioned solid wetting agent is added to the ink, the ink does not wet a nozzle plate, and can be stably ejected from the ink jet nozzles. When a compound selected from trimethylolpropane, 1,2,6-hexanetriol, a saccharide and a sugar alcohol is used as the solid wetting agent, the above-mentioned effect which is particularly excellent is obtained.

The total amount of the above-mentioned solid wetting agents added to the ink is preferably from 3 to 20% by weight, and more preferably from 3 to 10% by weight, based on the total weight of the ink. When two or more kinds of solid wetting agents are used as a mixture, it is preferred to combine at least one selected from a saccharide, a sugar alcohol and a hyaluronate with at least one selected from trimethylolpropane and 1,2,6-hexanetriol. When the solid wetting agents are added in this combination, an increase in the viscosity of the ink can be restrained.

The effect of preventing the clogging of the ink jet nozzles is obtained by adjusting the amount of the solid wetting agents contained in the ink to 3% by weight or more, and the ink having sufficiently low viscosity for stably ejecting the ink from the ink jet nozzles can be obtained by adjusting the amount of the solid wetting agents contained in the ink to 20% by weight or less.

In the above-mentioned latter embodiment, the acetylene glycol-based surfactant and/or the acetylene alcohol-based surfactant of (3) are added to the ink, and these surfactants are added preferably in a total amount of 0.01 to 10% by weight, and more preferably in a total amount of 0.1 to 5% by weight, based on the total weight of the ink.

Such an ink for ink jet recording is excellent particularly in dispersion stability and ejection stability, which causes no clogging of the nozzles for a long period of time. Accordingly, stable printing is possible. Further, on the recording media such as plain paper, recycled paper and coated paper, there can be obtained high-quality images having good drying properties after printing, no blurring, high print density and excellent color developability.

In general, when a pigment is dispersed, a dispersant such as a surfactant or a polymer dispersant is used. Such a dispersant is merely adsorbed on surfaces of pigment particles, so that the dispersant usually tends to be eliminated from the surfaces of the pigment particles by some kind of environmental factor. In contrast, according to the embodiment of the invention, the surfaces of the pigment particles having hydroxyl groups thereon are completely covered with a polymer coating or a crosslinked polymer coating, and the polymer coating or the crosslinked polymer coating surrounding the surfaces of the pigment particles is extremely strongly fixed to the surfaces of the pigment particles, as described above. It is therefore conceivable that the dispersant becomes difficult to be eliminated from the surfaces of the pigment particles.

More particularly, in an ink using a pigment dispersion in which a pigment is dispersed with the surfactant or the polymer dispersant, and improved in penetrability with the above-mentioned acetylene glycol-based surfactant and/or the acetylene alcohol-based surfactant and the penetrant such as diethylene glycol monobutyl ether, triethylene glycol monobutyl ether, propylene glycol monobutyl ether, dipropylene glycol monobutyl ether or a 1,2-alkyldiol, the dispersant tends to be easily eliminated from the surfaces of the pigment particles by strong shear force applied when the ink is ejected through fine nozzles, which causes deteriorated dispersibility, resulting in unstable ejection.

In contrast, in the ink for ink jet recording of the invention using the microencapsulated pigment according to the embodiment of the invention, such a phenomenon is not observed at all, and the ink is stably ejected. Further, the pigment particles are covered with the polymer coating or the crosslinked polymer coating, so that good solvent resistance is obtained. Accordingly, acceleration of elimination from the pigment particles due to the above-mentioned penetrant and swelling of the polymer become difficult to occur, thereby being able to maintain excellent dispersion stability for a long period of time.

Further, in the ink composition using the pigment dispersion in which the pigment is dispersed with the dispersant such as the surfactant or the polymer dispersant, and improved in penetrability, the viscosity of the ink composition tends to increase due to the dispersant dissolved in the solution without being adsorbed on the surfaces of the pigment particles from the beginning of dispersion or the dispersant thereafter eliminated from the pigment, so that the content of the pigment is limited in many cases. Accordingly, particularly on plain paper or recycled paper, sufficient print density cannot be obtained to fail to obtain good color developability in many cases. In contrast, in the ink composition using the microencapsulated pigment according to the embodiment of the invention, the pigment particles are covered with the polymer coating or the crosslinked polymer coating as described above, so that the dispersant is difficult to be removed from the pigment particles. Accordingly, there is no increase in the viscosity of the ink composition, which makes it easy to lower the viscosity of the ink composition. The ink composition has therefore the advantage that it can contain more pigment particles, and sufficient print density can be obtained on plain paper or recycled paper.

In the particularly preferred embodiment of the invention described above, the above-mentioned acetylene glycol-based surfactant and/or acetylene alcohol-based surfactant of (2) is added preferably in an amount of 0.01 to 10% by weight, and more preferably in an amount of 0.1 to 5% by weight, based on the total weight of the ink.

In the particularly preferred embodiment of the invention described above, the above-mentioned diethylene glycol monobutyl ether or triethylene glycol monobutyl ether of (3) as the penetrant is added preferably in an amount of 10% by weight or less, and more preferably in an amount of 0.5 to 5% by weight, based on the total weight of the ink composition. Addition of diethylene glycol monobutyl ether or triethylene glycol monobutyl ether exhibits the remarkable effect of improving penetrability. Addition of diethylene glycol monobutyl ether and/or triethylene glycol monobutyl ether is available for improving solubility of the acetylene glycol-based surfactant and improving print quality.

In the particularly preferred embodiment of the invention described above, the 1,2-alkylenediol having 4 to 10 carbon atoms of (3) as the penetrant is added preferably in an amount of 15% or less based on the total weight of the ink. When the 1,2-alkyldiol having 3 or less carbon atoms is used, sufficient penetrability is not obtained. The 1,2-alkyldiol having carbon atoms exceeding 15 is unfavorable because it becomes difficult to dissolve in water. When the amount of the 1,2-alkyldiol added exceeds 15% by weight, the viscosity of the ink unfavorably tends to increase. Specifically, 1,2-pentanediol or 1,2-hexanediol is preferably used as the 1,2-alkyldiol. Either one can be used alone, or both can be used in combination. The 1,2-pentanediol is preferably added in an amount ranging from 0.1 to 15% by weight. In particular, when 1,2-hexanediol is used, it is preferably added in an amount ranging from 0.5 to 10% by weight. Less than 0.5% by weight results in failure to obtain good penetrability.

Further, particularly, in the ink for ink jet recording according to the embodiment of the invention, in order to enhance the characteristic that the clogging is difficult to be generated (clogging reliability), and in order to inhibit the occurrence of unwilled white blanks in an image region of the resulting printed matter, the solid wetting agent is preferably added in an amount of 3 to 20% by weight based on the total weight of the ink.

In this specification, the solid wetting agent means a water-soluble substance which is solid at ordinary temperature (25° C.) and has a water-retaining function. Particularly preferred examples of the solid wetting agents include a saccharide, a sugar alcohol, a hyaluronate, trimethylolpropane and 1,2,6-hexanetriol. Examples of the saccharides include a monosaccharide, a disaccharide, an oligosaccharide (including a trisaccharide and a tetrasaccharide) and a polysaccharide. Preferred examples thereof include glucose, mannose, fructose, ribose, xylose, arabinose, galactose, aldonic acid, glucitol, (sorbit), maltose, cellobiose, lactose, sucrose, trehalose and maltotriose. The term “polysaccharide” as used herein means a saccharide in its broad sense, and is used in the sense that it includes substances widely occurring in nature such as alginic acid, α-cyclodextrin and cellulose. Further, derivatives of these saccharides include a reduced sugar of the above-mentioned saccharide (for example, a sugar alcohol represented by the general formula HOCH₂(CHOH)ₙCH₂OH (wherein n represents an integer of 2 to 5), an oxidized sugar (for example, an aldonic acid or a uronic acid), an amino acid and a thiosugar. In particular, a sugar alcohol is preferred, and specific examples thereof include maltitol, sorbitol and xylitol. As the hyaluronate, there can be used a product commercially available as a 1% aqueous solution of sodium hyaluronate (molecular weight: 350,000). These solid wetting agents are used either alone or as a mixture of two or more thereof.

The use of the solid wetting agent can restrain the evaporation of water by its water retaining function, so that the viscosity does not increase in flow paths of the ink or in the vicinities of ink jet nozzles, and a film is difficult to be formed, resulting in difficulty of clogging. Further, the above-mentioned solid wetting agent is chemically stable, so that it does not decompose in the ink, and the performance of the ink can be maintained for a long period of time. Furthermore, even when the above-mentioned solid wetting agent is added to the ink, the ink does not wet a nozzle plate, and can be stably ejected.

In the invention, when the above-mentioned solid wetting agents are used alone, the content thereof is preferably from 3 to 20% by weight, and more preferably from 3 to 10% by weight, based on the total weight of the ink. When two or more thereof are used as a mixture, the total amount of two or more thereof is preferably from 3 to 20% by weight, and more preferably from 3 to 10% by weight, based on the total weight of the ink for ink jet recording. When two or more thereof are used as a mixture, preferred is a combination of one selected from the group consisting of a saccharide, a sugar alcohol and a hyaluronate and one selected from the group consisting of trimethylolpropane and 1,2,6-hexanetriol. This combination is preferred because an increase in the viscosity of the ink by addition can be restrained. When the content of the solid wetting agents is less than 3% by weight, the sufficient effect of improving the clogging is not obtained. On the other hand, exceeding 20% by weight results in the tendency of the harmful effect to occur that the viscosity increases to become hard to obtain stable ejection.

Although the ink for ink jet recording according to the embodiment of the invention has been described above, the microencapsulated pigment according to the embodiment of the invention contained as the colorant is small in the particle size of the colorant particles, and shaped like a true sphere. Accordingly, flowability of the ink easily becomes Newtonian. Further, the hydrophilic groups on the surface are regularly densely orientated toward the aqueous medium side, so that electrostatic repulsion is considered to be effectively generated. There can be therefore prepared the ink for ink jet recording which is excellent in ejection stability, more excellent in dispersibility (high dispersibility) and dispersion stability and further improved in the concentration of the colorant contained, compared to the conventional microencapsulated pigments.

The ink jet recording can be suitably achieved by mounting the ink for ink jet recording according to the embodiment of the invention on a known ink jet printer, and printing the ink on the recording medium such as plain paper or an ink jet recording medium. This allows ejection stability of the ink from a recording head to be excellent, and can provide the recorded matter which is excellent in fastness, abrasion resistance and color developability of images, and high in image density of images, and in which images are hard to blur. Further, even when plain paper is used as the recording medium, the recorded matter is obtained in which images are hard to blur, and which is excellent in color developability of images.

### EXAMPLES

The present invention will be illustrated in greater detail with reference to the following Examples and Comparative Examples, but the invention should not be construed as being limited thereto.

Preparation of Microencapsulated Pigment “MCP1”

A hundred grams of a wet cyan pigment (C.I. Pigment Blue 15:3 having a water content of 60%), 10 g of a polymerizable surfactant, Aqualon KH-10, and 50 g of ion exchanged water were added and mixed, and then, dispersed in an Eiger Motor Mill, Model 250 (manufactured by Eiger Japan Co., Ltd.) under the conditions of a bead loading of 70% and 5,000 revolutions for 1 hour. This was put into a reaction vessel equipped with a stirrer, a reflux condenser, a dropping funnel, a temperature controller, a nitrogen-introducing pipe and an ultrasonic generator. Then, after the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, a 5-fold excess of isopropyl alcohol was added to precipitate a polymerization product, and the polymerization product was further sedimented with a centrifugal separator to remove a supernatant. Then, 250 g of ion exchanged water was added thereto, followed by irradiation with an ultrasonic wave of 45 KHz for 30 minutes to disperse the product again. The resulting dispersion was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP1”.

The number average particle size was measured with a laser doppler system size distribution analyzer, Microtrac UPA150, manufactured by Leads & Northlop Co. As a result, it was about 300 nm.

Preparation of Microencapsulated Pigment “MCP2”

A hundred grams of a wet magenta pigment (C.I. Pigment Red 122 having a water content of 60%), 10 g of a polymerizable surfactant, Aqualon KH-10, 12 g of benzyl methacrylate, 8 g of dodecyl methacrylate and 50 g of ion exchanged water were added and mixed, followed by dispersion treatment in a Microfluidizer M-140K (manufactured by Microfluidics Corporation) for 1 hour. This was put into a reaction vessel equipped with a stirrer, a reflux condenser, a dropping funnel, a temperature controller, a nitrogen-introducing pipe and an ultrasonic generator. Then, after the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, a 5-fold excess of isopropyl alcohol was added to precipitate a polymerization product, and the polymerization product was further sedimented with a centrifugal separator to remove a supernatant. Then, 250 g of ion exchanged water was added thereto, followed by irradiation with an ultrasonic wave of 45 KHz for 30 minutes to disperse the product again. The resulting dispersion was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP2”.

The number average particle size was measured with a laser doppler system size distribution analyzer, Microtrac UPA150, manufactured by Leeds & Northrop Co. As a result, it was about 300 nm.

Preparation of Microencapsulated Pigment “MCP3”

A hundred grams of a wet yellow pigment (C.I. Pigment Yellow 17 having a water content of 60%), 15 g of a polymerizable surfactant, Adeka Reasoap SE-10N, 5 g of isobornyl methacrylate, 8 g of dodecyl methacrylate, 0.5 g of 2-acrylamido-2-methylpropanesulfonic acid and 50 g of ion exchanged water were added and mixed, and then, dispersed in an Eiger Motor Mill, Model 250 (manufactured by Eiger Japan Co., Ltd.) under the conditions of a bead loading of 70% and 5,000 revolutions for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, the resulting product was filtered through a membrane filter having a pore size of 1 μm to remove coarse particles, and then, subjected to ultrafiltration. Then, 150 g of ion exchanged water was added thereto, followed by irradiation with an ultrasonic wave of 45 KHz for 30 minutes to disperse the product. The resulting dispersion was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP3”.

The number average particle size was measured with a laser doppler system size distribution analyzer, Microtrac UPA150, manufactured by Leeds & Northrop Co. As a result, it was about 300 nm.

Preparation of Microencapsulated Pigment “MCP4”

A hundred grams of a wet cyan pigment (C.I. Pigment Blue 15:4 having a water content of 60%), 15 g of a polymerizable surfactant, Aqualon KH-10, 7 g of benzyl methacrylate, 4 g of dodecyl methacrylate, 0.1 g of diethylene glycol dimethacrylate, 0.5 g of 2-acrylamido-2-methylpropanesulfonic acid and 50 g of ion exchanged water were added and mixed, followed by dispersion treatment in a Microfluidizer M-140K (manufactured by Microfluidics Corporation) for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, the resulting product was filtered through a membrane filter having a pore size of 1 μm to remove coarse particles, and then, subjected to ultrafiltration. Then, 150 g of ion exchanged water was added thereto, followed by irradiation with an ultrasonic wave of 45 KHz for 30 minutes to disperse the product. The resulting dispersion was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP4”.

The number average particle size was measured with a laser doppler system size distribution analyzer, Microtrac UPA150, manufactured by Leeds & Northrop Co. As a result, it was about 280 nm.

Preparation of Microencapsulated Pigment “MCP5”

2-Methoxybenzamino-5-N,N′-diethylaminosulfonyl chloride (25.8 g) was normally diazotized to obtain a diazonium salt. This was mixed and coupled with a ground normally prepared from 38 g of 2-hydroxynaphthalene-3-carboyl-5′-chloro-2′,4′-dimethoxyanilide to obtain a slurry of C.I. Pigment Red 5. To 20 g of this slurry, 10 g of Aqualon KH-10 and 100 g of ion exchanged water were added and mixed, followed by dispersion treatment in a Microfluidizer M-140K (manufactured by Microfluidics Corporation) for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, a 5-fold excess of isopropyl alcohol was added to precipitate a polymerization product, and the polymerization product was further sedimented with a centrifugal separator to remove a supernatant. Then, 40 g of ion exchanged water was added thereto, followed by irradiation with an ultrasonic wave of 45 KHz for 30 minutes to disperse the product again. This was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP5”.

The number average particle size was measured with a laser doppler system size distribution analyzer, Microtrac UPA150, manufactured by Leeds & Northrop Co. As a result, it was about 280 nm.

Preparation of Microencapsulated Pigment “MCP6”

xx 3,3′-Dichlorobenzine (17.4 g) was normally tetrazotized to obtain a tetrazonium salt. On the other hand, 29.5 g of acetoacet-meta-xylidide and 0.4 g of acetoacetanilide parasulfonic acid were dissolved by mixing in the presence of an alkali to prepare a ground by a conventional method. Both solutions were mixed and coupled with each other to form a suspension of a pigment. To 20 g of this suspension, 5 g of a polymerizable surfactant, Adeka Reasoap SE-10N, 2 g of benzyl methacrylate, 3.14 g of n-butyl methacrylate and 50 g of ion exchanged water were added and mixed, and then, dispersed in an Eiger Motor Mill, Model 250 (manufactured by Eiger Japan Co., Ltd.) under the conditions of a bead loading of 70% and 5,000 revolutions for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, the resulting product was filtered through a membrane filter having a pore size of 1 μm to remove coarse particles, and then, subjected to ultrafiltration. Then, the resulting dispersion was adjusted to pH 9 with a 2 mol/l aqueous solution of potassium hydroxide, and filtered through a membrane filter having a pore size of 1 μm to remove coarse particles, thus obtaining a dispersion of desired microencapsulated pigment “MCP6”.

The number average particle size was measured with a laser doppler system size distribution analyzer, Microtrac UPA150, manufactured by Leeds & Northrop Co. As a result, it was about 280 nm.

Preparation of Microencapsulated Pigment Dispersion “MCP20”

A hundred grams of a wet cyan pigment (C.I. Pigment Blue 15:3 having a water content of 60%), 10 g of a polymerizable surfactant, Aqualon KH-10, and 50 g of ion exchanged water were added and mixed, and then, dispersed in an Eiger Motor Mill, Model 250 (manufactured by Eiger Japan Co., Ltd.) under the conditions of a bead loading of 70% and 5,000 revolutions for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, a 5-fold excess of isopropyl alcohol was added to precipitate a polymerization product, and the polymerization product was further sedimented with a centrifugal separator to remove a supernatant. Then, 250 g of ion exchanged water was added thereto, followed by irradiation with an ultrasonic wave of 45 KHz for 30 minutes to disperse the product again. The resulting dispersion was adjusted to pH 9 with a 2 mol/l aqueous solution of potassium hydroxide, and filtered through a membrane filter having a pore size of 1 μm to remove coarse particles, thus obtaining a dispersion of a desired microencapsulated pigment.

The above-mentioned microencapsulated pigment dispersion was partly centrifuged with a centrifugal separator at 20,000 revolutions for 30 minutes. A supernatant obtained by this operation was diluted 1,000 times, and the absorbance at 200 to 400 nm was measured with a spectrophotometer. Using a calibration curve of Aqualon KH-10 at specified wavelength previously determined, the content of Aqualon KH-10 in the supernatant was calculated to determine the unreacted amount thereof. The amount of the unreacted product was 30% by weight for Aqualon KH-10.

On the other hand, the above-mentioned microencapsulated pigment dispersion was subjected ultrafiltration by the cross flow process using an ultrafiltration equipment. For a part of the dispersion ultrafiltrated, the unreacted amount was determined from the content of Aqualon KH-10 in the supernatant in the same manner as described above. The amount of an unreacted product was less than 10,000 ppm for Aqualon KH-10.

For ultrafiltrated microencapsulated pigment dispersion “MCP20” thus obtained, the volume average particle size was measured with a laser doppler system size distribution analyzer, Microtrac UPA150, manufactured by Leeds & Northrop Co. As a result, it was 110 nm.

Preparation of Microencapsulated Pigment Dispersion “MCP21”

A hundred grams of a wet cyan pigment (C.I. Pigment Red 122 having a water content of 60%), 10 g of a polymerizable surfactant, Aqualon KH-10, 12 g of benzyl methacrylate, 8 g of dodecyl methacrylate and 50 g of ion exchanged water were added and mixed, followed by dispersion treatment in a Microfluidizer M-140K (manufactured by Microfluidics Corporation) for 1 hour. This was put into a reaction vessel equipped with a stirrer, a reflux condenser, a dropping funnel, a temperature controller, a nitrogen-introducing pipe and an ultrasonic generator. After the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, a 5-fold excess of isopropyl alcohol was added to precipitate a polymerization product, and the polymerization product was further sedimented with a centrifugal separator to remove a supernatant. Then, 250 g of ion exchanged water was added thereto, followed by irradiation with an ultrasonic wave of 45 KHz for 30 minutes to disperse the product again. The resulting dispersion was adjusted to pH 9 with a 2 mol/l aqueous solution of potassium hydroxide, and filtered through a membrane filter having a pore size of 1 μm to remove coarse particles, thus obtaining a dispersion of a desired microencapsulated pigment.

The above-mentioned microencapsulated pigment dispersion was partly centrifuged with a centrifugal separator at 20,000 revolutions for 30 minutes. A supernatant obtained by this operation was separated by liquid chromatography. Using a calibration curve of Aqualon KH-10 previously determined, the content of Aqualon KH-10 in the supernatant was determined. Further, a specified amount of n-hexane was added to a part of the above-mentioned microencapsulated pigment dispersion, followed by sufficient mixing. Then, the resulting dispersion was centrifuged at 20,000 revolutions for 30 minutes with a centrifugal separator, and a separated n-hexane layer was extracted. The extracted components were separated by liquid chromatography. From the calibration curves of benzyl methacrylate and dodecyl methacrylate previously determined, the contents of benzyl methacrylate and dodecyl methacrylate extracted with n-hexane were determined. From these, the unreacted amounts of Aqualon KH-10, benzyl methacrylate and dodecyl methacrylate were determined. The amounts of the unreacted products were 30% by weight for Aqualon KH-10, 10% by weight for benzyl methacrylate, and 10% by weight for dodecyl methacrylate.

On the other hand, the above-mentioned microencapsulated pigment dispersion was subjected to ultrafiltration by the cross flow process using an ultrafiltration equipment. For a part of the dispersion ultrafiltrated, the unreacted amounts were determined from the content of Aqualon KH-10 in the supernatant and the contents of benzyl methacrylate and dodecyl methacrylate in an extract obtained by extracting a part of the ultrafiltrated dispersion with n-hexane, in the same manner as described above. The total concentration of Aqualon KH-10, benzyl methacrylate and dodecyl methacrylate was less than 10,000 ppm.

For the resulting dispersion, the volume average particle size was measured with a laser doppler system size distribution analyzer, Microtrac UPA150, manufactured by Leeds & Northrop Co. As a result, it was 130 nm. Further, the resulting dispersion ultrafiltrated was dried at room temperature, and the glass transition temperature thereof was measured with a DSC200 thermal scanning calorimeter (differential scanning calorimeter: DSC) manufactured by Seiko Denshi Co., Ltd. As a result, it was −7° C.

The results of measurements of the aspect ratio and the Zingg index of microencapsulated pigments “MCP1” to “MCP6”, “MCP20” and “MCP21” are shown in Table 1.

TABLE 1

| | Microencapsulated Pigment | | | | | | | |
|---|---|---|---|---|---|---|---|---|
| | MCP | MCP | MCP | MCP | MCP | MCP | MCP | MCP |
| | 1 | 2 | 3 | 4 | 5 | 6 | 20 | 21 |
| Aspect Ratio | 1.0 | 1.0 | 1.0 | 1.0 | 1.0 | 1.0 | 1.0 | 1.0 |
| Zigg Index | 1.0 | 1.0 | 1.0 | 1.0 | 1.0 | 1.0 | 1.0 | 1.0 |

Preparation of Microencapsulated Pigments “MCP7” to “MCP10”

MCP7 (microencapsulated cyan pigment), MCP8 (micro-encapsulated cyan pigment), MCP9 (microencapsulated magenta pigment) and MCP10 (microencapsulated yellow pigment) were produced based on a method described in JP-10-140065 A.

Preparation of “MCP7”

A flask was charged with 250 g of methyl ethyl ketone, the temperature of which was elevated to 75° C. with stirring under a nitrogen seal. A mixed solution of 85 g of n-butyl methacrylate, 90 g of n-butyl acrylate, 40 g of 2-hydroxyethyl methacrylate, 25 g of methacrylic acid and 20 g of a polymerization initiator, Perbutyl O (tert-butyl peroxyoctoate manufactured by Nippon Oil & Fats Co., Ltd.) was added dropwise thereto for 2 hours, followed by further reaction for 15 hours to obtain a solution of a vinyl polymer.

Into a stainless steel beaker, 8 g of the above-mentioned polymer solution was put together with 0.4 g of dimethylethanolamine and 8 g of a cyan pigment (C.I. Pigment Blue 15:3), and ion exchanged water was further added to bring the total amount to 40 g. Then, 250 g of zirconia beads having an average particle size of 0.5 mm was added thereto, followed by kneading with a sand mill for 4 hours. After the termination of the kneading, the zirconia beads were removed by filtration to obtain an aqueous dispersion in which a dispersion comprising the polymer having the carboxyl group neutralized with the base and the pigment was dispersed in water. A 1 N hydrochloric acid was added to the resulting dispersion with stirring with a dispersing device at ordinary temperature until the resin was insolubilized to be firmly fixed to the pigment. At this time, the pH was 3 to 5. The aqueous medium containing the pigment to which the polymer was firmly fixed was filtered by suction and washed with water to obtain a wet cake. A 10% aqueous solution of NaOH added thereto, while stirring the wet cake with a dispersing device, until the pH of the dispersion reached 8.5 to 9.5, and stirring was continued for 1 hour. Then, ion exchanged water was added to adjust the solid concentration to 20%, thereby obtaining microencapsulated pigment MCP7 of carbon black. The aspect ratio thereof was 1.4, and the Zingg index thereof was 1.4.

The number average particle size was measured with a laser doppler system size distribution analyzer, Microtrac UPA150, manufactured by Leeds & Northrop Co. As a result, it was about 180 nm.

Preparation of “MCP8”

A flask was charged with 250 g of methyl ethyl ketone, the temperature of which was elevated to 75° C. with stirring under a nitrogen seal. A mixed solution of 155 g of n-butyl methacrylate, 20 g of n-butyl acrylate, 35 g of 2-hydroxyethyl methacrylate, 40 g of methacrylic acid and 5 g of a polymerization initiator, Perbutyl O, was added dropwise thereto for 2 hours, followed by further reaction for 15 hours to obtain a solution of a vinyl polymer.

Into a stainless steel beaker, 10 g of the above-mentioned polymer solution, 7 g of a cyan pigment (C.I. Pigment Blue 15:3), 40 g of methyl ethyl ketone and 150 g of ceramic beads having an average particle size of 0.5 mm were put, and dispersed with a beads mill dispersing device. Thereafter, the ceramic beads were removed by filtration to prepare a paste for a microencapsulated pigment.

Then, 20 g of the above-mentioned paste for a micro-encapsulated pigment was mixed with 0.2 g of diethanolamine to form an organic solvent phase, and 25 g of ion exchanged water was added dropwise for 20 minutes to the organic solvent phase with stirring while irradiating an ultrasonic wave to cause phase reversal of emulsion, thereby obtaining a microencapsulated pigment-containing aqueous dispersion.

Further, the microencapsulated pigment-containing aqueous dispersion was further distilled at 85° C., thereby removing the solvent. Thus, microencapsulated pigment MCP8 of C.I. Pigment Blue 15:3 was obtained. The aspect ratio thereof was 1.4, and the Zingg index thereof was 1.4.

The number average particle size was measured with a laser doppler system size distribution analyzer, Microtrac UPA150, manufactured by Leeds & Northrop Co. As a result, it was about 180 nm.

Production of “MCP9”

A flask was charged with 250 g of methyl ethyl ketone, the temperature of which was elevated to 75° C. with stirring under a nitrogen seal. A mixed solution of 170 g of n-butyl methacrylate, 58 g of n-butyl acrylate, 35 g of 2-hydroxyethyl methacrylate, 35 g of acrylic acid and 20 g of a polymerization initiator, Perbutyl O, was added dropwise thereto for 2 hours, followed by further reaction for 15 hours to obtain a solution of a vinyl polymer.

Into a stainless steel beaker, 15 g of the above-mentioned polymer solution was put together with 0.8 g of dimethylethanolamine and 15 g of a magenta pigment (C.I. Pigment Red 122), and ion exchanged water was further added to bring the total amount to 75 g. Then, 250 g of zirconia beads having an average particle size of 0.5 mm was added thereto, followed by kneading with a sand mill for 4 hours. After the termination of the kneading, the zirconia beads were removed by filtration to obtain an aqueous dispersion in which a dispersion comprising the polymer having the carboxyl group neutralized with the base and the pigment was dispersed in water. A 1 N hydrochloric acid was added to the resulting dispersion with stirring with a dispersing device at ordinary temperature until the resin was insolubilized to be firmly fixed to the pigment. At this time, the pH was 3 to 5. The aqueous medium containing the pigment to which the polymer was firmly fixed was filtered by suction and washed with water to obtain a wet cake. A 10% aqueous solution of NaOH added thereto, while stirring the wet cake with a dispersing device, until the pH of the dispersion reached 8.5 to 9.5, and stirring was continued for 1 hour. Then, ion exchanged water was added to adjust the solid concentration to 20%, thereby obtaining microencapsulated pigment MCP9 of C.I. Pigment Red 122. The aspect ratio thereof was 1.4, and the Zingg index thereof was 1.4.

The number average particle size was measured with a laser doppler system size distribution analyzer, Microtrac UPA150, manufactured by Leeds & Northrop Co. As a result, it was about 250 nm.

Production of “MCP10”

A flask was charged with 250 g of methyl ethyl ketone, the temperature of which was elevated to 75° C. with stirring under a nitrogen seal. A mixed solution of 170 g of n-butyl methacrylate, 5 g of n-butyl acrylate, 35 g of 2-hydroxyethyl methacrylate, 35 g of acrylic acid and 20 g of a polymerization initiator, Perbutyl O, was added dropwise thereto for 2 hours, followed by further reaction for 15 hours to obtain a solution of a vinyl polymer.

Into a stainless steel beaker, 15 g of the above-mentioned polymer solution was put together with 0.8 g of dimethylethanolamine and 15 g of a yellow pigment (C.I. Pigment Yellow 110), and ion exchanged water was further added to bring the total amount to 75 g. Then, 250 g of zirconia beads having an average particle size of 0.5 mm was added thereto, followed by kneading with a sand mill for 4 hours. After the termination of the kneading, the zirconia beads were removed by filtration to obtain an aqueous dispersion in which a dispersion comprising the polymer having the carboxyl group neutralized with the base and the pigment was dispersed in water. A 1 N hydrochloric acid was added to the resulting dispersion with stirring with a dispersing device at ordinary temperature until the resin was insolubilized to be firmly fixed to the pigment. At this time, the pH was 3 to 5. The aqueous medium containing the pigment to which the polymer was firmly fixed was filtered by suction and washed with water to obtain a wet cake. A 10% aqueous solution of NaOH added thereto, while stirring the wet cake with a dispersing device, until the pH of the dispersion reached 8.5 to 9.5, and stirring was continued for 1 hour. Then, ion exchanged water was added to adjust the solid concentration to 20%, thereby obtaining microencapsulated pigment MCP10 of C.I. Pigment Yellow 110. The aspect ratio thereof was 1.4, and the Zingg index thereof was 1.4.

The number average particle size was measured with a laser doppler system size distribution analyzer, Microtrac UPA150, manufactured by Leeds & Northrop Co. As a result, it was about 180 nm.

Preparation of “MCP11”

Forty grams of a commercially available magenta pigment (C.I. Pigment Red 122, HOSTAPERM PINK EB TRANS manufactured by Clariant), 8 g of a polymerizable surfactant, Aqualon KH-10, 5 g of benzyl methacrylate, 8 g of dodecyl methacrylate and 200 g of ion exchanged water were added and mixed, followed by irradiation with an ultrasonic wave of 45 KHz for 1 hour. This was put into a reaction vessel equipped with a stirrer, a reflux condenser, a dropping funnel, a temperature controller, a nitrogen-introducing pipe and an ultrasonic generator. Then, after the internal temperature of the reaction vessel was elevated to 80° C., an aqueous solution of 0.2 g of potassium persulfate, a polymerization initiator, dissolved in 10 g of ion exchanged water was added dropwise, and polymerization was conducted at 80° C. for 3 hours, while introducing nitrogen into the reaction vessel. After the termination of the polymerization, the number average particle size was measured with a laser doppler system size distribution analyzer, Microtrac UPA150, manufactured by Leads & Northlop Co. As a result, it was about 7 μm.

As described above, microencapsulated pigments “MCP1” to “MCP6” of Examples had a particle size of 300 nm or less, and further, “MCP20” and “MCP21” had a particle size of 150 nm or less. They had an aspect ratio of 1.0 and a Zingg index of 1.0 to show a true sphere shape. In contrast, microencapsulated pigments “MCP7” to “MCP11” of Comparative Examples had a particle size of 160 nm or more, and “MCP7” to “MCP10” had an aspect ratio of larger than 1.3 and a Zingg index of larger than 1.3 to show no true sphere shape. The aspect ratio and the Zingg index were determined by diluting the aqueous dispersion 100 times with ion exchanged water, drying it, observing the particles under a transmission electron microscope (TEM) and a scanning electron microscope (SEM), and measuring the major and minor diameters and thickness of the particles.

Then, surface-treated organic pigments “P1” to “P5” (corresponding to conventional examples) were produced.

The “amount of hydrophilic groups introduced onto surfaces of pigment particles” shown below was determined by the following methods:

Determination of Amount of Hydrophilic Groups (Anionic Groups) Introduced

When Hydrophilic Groups were Introduced with a Sulfonating Agent

Pigment particles whose surfaces are treated with a sulfonating agent were treated by an oxygen flask combustion method, and a 0.3% aqueous solution of hydrogen peroxide was absorbed by the pigment particles. Then, the sulfuric ion (bivalent) was determined by ion chromatography (Dionex Corporation; 2000i). The resulting value was converted to the value of the sulfonic acid group, and indicated as the equivalent per g of pigment.

When Hydrophilic Groups were Introduced with a Carboxylating Agent

As a technique, the Zeisel method was used. Diazomethane was dissolved in an appropriate solvent, and the resulting solution was added dropwise to convert all active hydrogen atoms on the surfaces of the pigment particles to methyl groups. Hydroiodic acid having a specific gravity of 1.7 was added to the pigment thus treated, followed by heating to vaporize the methyl groups as methyl iodide. The gas of methyl iodide was trapped with a silver nitrate solution to precipitate as methylsilver iodide. The amount of the original methyl groups, that is, the amount of active hydrogens, was measured from the weight of the silver iodide, and indicated as the molar quantity per g of pigment (mmol/g).

Preparation of Black Pigment Particles “P1” Having Hydrophilic Groups (Anionic Groups) on Their Surfaces

Carbon black (“MA-7” manufactured by Mitsubishi Chemical Corporation) (15 parts) was mixed with 200 parts of sulfolane (a sulfonating agent), and dispersed in an Eiger Motor Mill, M250 (manufactured by Eiger Japan Co., Ltd.) under the conditions of a bead loading of 70% and 5,000 revolutions for 1 hour. A mixed solution of a pigment paste dispersed and a solvent was transferred to an evaporator, and heated at 120° C. while reducing the pressure to 30 mmHg or lower, thereby removing water contained in the system by distillation as much as possible. Thereafter, the temperature was controlled to 150° C., and then, 25 parts of sulfur trioxide was added, and allowed to react for 6 hours. After the termination of the reaction, the reaction product was washed several times with excess sulfolane, poured into water, and filtered, thereby obtaining black pigment particles “P1”.

The amount of the hydrophilic groups (anionic groups) introduced into the resulting black pigment particles “P1” was 0.12 mmol per g of pigment.

Preparation of Black Pigment Particles “P2” Having Hydrophilic Groups (Anionic Groups) on Their Surfaces

After commercially available acidic carbon black (“MA-100” manufactured by Mitsubishi Chemical Corporation) (300 g) was thoroughly mixed with 1,000 ml of water, 450 g of sodium hypochlorite (effective chlorine concentration: 12%) was added dropwise thereto, followed by stirring at 80° C. for 15 hours. The resulting slurry was washed repeatedly with ion exchanged water while filtering it through Toyo filter paper No. 2. As a measure of the completion of washing, the slurry was washed until white turbidity became disappeared when a 0.1 N aqueous solution of silver nitrate was added to the ion exchanged waster that passed through the filter. This pigment slurry was dispersed again in 2,500 ml of water, and desalted through a reverse osmosis membrane until the electric conductance reached 0.2 microsiemens or less. Further, the slurry was concentrated so as to give a pigment concentration of about 15% by weight.

The resulting surface-treated pigment dispersion was acid treated (acidified with aqueous hydrochloric acid), concentrated, dried and finely pulverized to obtain a powder. As for this surface-treated carbon black powder, the surface-active hydrogen content was measured by the above-mentioned method. As a result, it was 2.8 mmol/g.

Preparation of Cyan Pigment Particles “P3” Having Hydrophilic Groups (Anionic Groups) on Their Surfaces

A phthalocyanine pigment (C.I. Pigment Blue 15:3) (20 parts) was mixed with 500 parts of quinoline, and dispersed in an Eiger Motor Mill, M250 (manufactured by Eiger Japan Co., Ltd.) under the conditions of a bead loading of 70% and 5,000 revolutions for 2 hours. A mixed solution of a pigment paste dispersed and a solvent was transferred to an evaporator, and heated at 120° C. while reducing the pressure to 30 mmHg or lower, thereby removing water contained in the system by distillation as much as possible. Thereafter, the temperature was controlled to 150° C., and then, 20 parts of a sulfonated pyridine complex (a sulfonating agent) was added, and allowed to react for 8 hours. After the termination of the reaction, the reaction product was washed several times with excess quinoline, poured into water, and filtered, thereby obtaining cyan pigment particles “P3” having hydrophilic groups (anionic groups) on their surfaces.

The amount of the hydrophilic groups (anionic groups) introduced into the resulting cyan pigment particles “P3” was 0.04 mmol/g.

Preparation of Yellow Pigment Particles “P4” Having Hydrophilic Groups (Anionic Groups) on Their Surfaces

Yellow pigment particles “P4” having the hydrophilic groups (anionic groups) on their surfaces were obtained by the same treating method as with the above-mentioned “preparation of cyan pigment particles “P3” having the hydrophilic groups on their surfaces” with the exception that “20 parts of the phthalocyanine pigment (C.I. Pigment Blue 15:3)” was substituted by “20 parts of an isoindolinone pigment (C.I. Pigment Yellow 110).

The amount of the hydrophilic groups (anionic groups) introduced into the resulting yellow pigment particles “P4” was 0.045 mmol/g.

Preparation of Magenta Pigment Particles “P5” Having Hydrophilic Groups (Anionic Groups) on Their Surfaces

Magenta pigment particles “P5” having the hydrophilic groups (anionic groups) on their surfaces were obtained by the same treating method as with the above-mentioned “preparation of cyan pigment particles “P3” having the hydrophilic groups on their surfaces” with the exception that “20 parts of the phthalocyanine pigment (C.I. Pigment Blue 15:3)” was substituted by “20 parts of an isoindolinone pigment (C.I. Pigment Red 122).

The amount of the hydrophilic groups (anionic groups) introduced into the resulting yellow pigment particles “P5” was 0.06 mmol/g.

Preparation of Inks for Ink Jet Recording

### Examples 1 to 8

Inks for ink jet recording of Examples 1 to 8 were prepared, based on compositions shown in Table 2.

TABLE 2

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Microencapsulated | MCP1 | 8 | 8 | 8 | | | | | |
| Pigment | MCP2 | | | | 8 | | | | |
| | MCP3 | | | | | 8 | | | |
| | MCP4 | | | | | | 8 | | |
| | MCP5 | | | | | | | 8 | |
| | MCP6 | | | | | | | | 8 |
| Wetting Agent | Glycerol | 15 | 13 | 12 | 13 | 13 | 13 | 13 | 13 |
| Penetrant | Diethylene glycol monobutyl ether | | 5 | 3 | | | 5 | 5 | |
| | Triethylene glycol monobutyl ether | | | | 2 | 5 | | | 2 |
| | 1,2-Hexanediol | | | 2 | 2 | 3 | 3 | | 2 |
| Solid Wetting Agent | Trimethylolpropane | | 5 | | 7 | 5 | 5 | 5 | 7 |
| | 1,2,6-Hexanetriol | | | 5 | | | | | |
| | Xylitol | 1 | | | | | 0.5 | | |
| Polar Solvent | 2-Pyrrolidone | | | | | | | | |
| Surfactant | Olfine E1010 | | | 1 | | | 1 | | |
| pH Adjuster | Potassium hydroxide | 0.1 | 0.1 | 0.1 | 0.1 | 0.1 | 0.1 | 0.1 | 0.1 |
| Preservative | Proxel XL-2 | 0.05 | 0.05 | 0.05 | 0.05 | 0.05 | 0.05 | 0.05 | 0.05 |
| Water | Ion exchanged water | bal. | bal. | bal. | bal. | bal. | bal. | bal. | bal. |

The amounts added are all indicated by % by weight.

The amounts of the microencapsulated pigments are indicated by the solid concentration.

### Comparative Examples 1 to 27

Inks for ink jet recording of Comparative Examples 1 to 27 were prepared, based on compositions shown in Tables 3 to 6.

TABLE 3
Ink Compositions of Inks for Ink Jet Recording of Comparative Examples
The amounts added are all indicated by % by weight.

| | | Comp. | Comp. | Comp. | Comp. | Comp. | Comp. | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Microencapsulated | MCP7 | 4 | | | | 8 | | | |
| Pigment | MCP8 | | 2 | | | | 4 | | |
| | MCP9 | | | 2 | | | | 8 | |
| | MCP10 | | | | 2 | | | | 6 |
| Wetting Agent | Glycerol | 15 | 15 | 12 | 12 | 15 | 10 | 10 | 15 |
| | Diethylene glycol | | | | | | 5 | 5 | |
| Penetrant | Diethylene glycol mono- | 6 | 6 | | | 7.5 | | 6 | |
| | butyl ether | | | | | | | | |
| | 1,2-Hexanediol | | | 6 | 6 | | 7.5 | | 6 |
| Surfactant | Surfynol 465 | 1 | 0.5 | 1 | 0.5 | 1 | 1 | 1 | 1 |
| | Polyoxyethylene nonyl | | | | | 0.5 | 0.5 | | |
| | phenyl ether | | | | | | | | |
| pH Adjuster | Potassium hydroxide | | | | | | | | 0.1 |
| | Propanolamine | 2 | 3 | 3 | 3 | 3 | 3 | 3 | |
| Preservative | Proxel XL | 0.05 | 0.05 | | | 0.05 | | 0.05 | |
| | 4,4-Dimethyloxazolidine | | | 1 | 1 | | 1 | | 1 |
| Water | Ion exchanged water | bal. | bal. | bal. | bal. | bal. | bal. | bal. | bal. |

TABLE 4
Ink Compositions of Inks for Ink Jet Recording of Comparative Examples

| | | Comparative | Comparative | Comparative | Comparative | Comparative |
|---|---|---|---|---|---|---|
| | | Example 9 | Example 10 | Example 11 | Example 12 | Example 13 |
| Pigment | P1 | 6 | | | | |
| | P2 | | 4 | | | |
| | P3 | | | 6 | | |
| | P4 | | | | 10 | |
| | P5 | | | | | 8 |
| Wetting Agent | Glycerol | 15 | 10 | 10 | 12 | 15 |
| | Diethylene glycol | | 2 | 2 | | |
| Penetrant | Diethylene glycol monobutyl ether | 6 | 3 | | 7.5 | |
| | 1,2-Hexanediol | | 3 | 6 | | 7.5 |
| Surfactant | Surfynol 465 | 1 | 1 | 1 | 1 | 1 |
| | Polyoxyethylene nonyl phenyl ether | | | 0.5 | 0.5 | |
| pH Adjuster | Potassium hydroxide | 0.5 | 0.5 | | | |
| | Propanolamine | | | 1 | 1 | 1 |
| Preservative | Proxel XL | 0.05 | 0.05 | | | 0.05 |
| | 4,4-Dimethyloxazolidine | | | 1 | 1 | |
| Water | Ion exchanged water | bal. | bal. | bal. | bal. | bal. |

The amounts added are all indicated by % by weight.

The amounts of the microencapsulated pigments are indicated by the solid concentration.

TABLE 5
Ink Compositions of Inks for Ink Jet Recording of Comparative Examples

| | | Comparative | Comparative | Comparative | Comparative | Comparative |
|---|---|---|---|---|---|---|
| | | Example 14 | Example 15 | Example 16 | Example 17 | Example 18 |
| Pigment | Carbon Black | 8 | 6 | | | |
| | C.I. Pigment Red 122 | | | 6 | | |
| | C.I. Pigment Blue 15:3 | | | | 6 | |
| | C.I. Pigment Yellow 185 | | | | | 6 |

| | | | | | |
|---|---|---|---|---|---|
| Ammonium Salt of Styrene-Acrylic Acid | 1 | 1 | 1 | 1 | 1 |
| Copolymer (molecular weight: 70,000, | | | | | |
| polymer composition: 38%) | | | | | |
| Glycerol | 15 | 10 | 10 | 15 | 10 |
| Diethylene glycol | 10 | 8 | 8 | 10 | 8 |
| 1,2-Hexanediol | | | | | 5 |
| 2-Pyrrolidone | | 2 | 2 | | 2 |
| Olfine E1010 | | 1 | 1 | | |
| Potassium hydroxide | 0.1 | 0.1 | 0.1 | 0.1 | 0.1 |
| Proxel XL-2 | 0.05 | 0.05 | 0.05 | 0.05 | 0.05 |
| Ion exchanged water | bal. | bal. | bal. | bal. | bal. |

The amounts added are all indicated by % by weight.

The amounts of the microencapsulated pigments are indicated by the solid concentration.

TABLE 6
Ink Compositions of Inks for Ink Jet Recording of Comparative Examples

| | | Comp. | Comp. | Comp. | Comp. | Comp. | Comp. | Comp. | Comp. | Comp. |
|---|---|---|---|---|---|---|---|---|---|---|
| | | Ex. 19 | Ex. 20 | Ex. 21 | Ex. 22 | Ex. 23 | Ex. 24 | Ex. 25 | Ex. 26 | Ex. 27 |
| Microencapsulated | MCP7 | 4 | | | | 8 | | | | |
| Pigment | MCP8 | | 3 | | | | 8 | | | |
| | MCP9 | | | 3 | | | | 8 | | |
| | MCP10 | | | | 3 | | | | 8 | |
| | MCP11 | | | | | | | | | 8 |

| | | | | | | | | | |
|---|---|---|---|---|---|---|---|---|---|
| Glycerol | 15 | 15 | 15 | 15 | 15 | 10 | 10 | 15 | 13 |
| Diethylene glycol | | | | | | 5 | 5 | | |
| Trimethylolpropane | | | | | | 6 | 6 | 6 | 3 |
| Diethylene glycol monobutyl ether | | | | | 8 | | | | |
| Triethylene glycol monobutyl ether | | | | | | | | | 3 |
| 1,3-Dimethyl-2-imidazolidinone | | | 2 | 2 | | | | | |
| 2-Pyrrolidone | 2 | 2 | | | | | | | |
| Olfine E1010 | | | | | | | | | 1 |
| Surfynol 465 | 1 | 1 | 1 | 1 | 1 | 1 | 1 | 1 | |
| Potassium hydroxide | 0.1 | 0.1 | 0.1 | 0.1 | 0.1 | 0.1 | 0.1 | 0.1 | 0.1 |
| Proxel XL-2 | 0.05 | 0.05 | 0.05 | 0.05 | 0.05 | 0.05 | 0.05 | 0.05 | 0.05 |
| Ion exchanged water | bal. | bal. | bal. | bal. | bal. | bal. | bal. | bal. | bal. |

The inks for ink jet recording of Examples 1 to 8, Comparative Examples 1 to 27 and recorded matter printed using these inks were evaluated by methods shown below.

Evaluation 1-1: Dispersibility 1

For each of the inks for ink jet recording of Examples and Comparative Examples, the storage modulus (Pa) at each angular speed at the time when the angular speed was applied from 0.5 rad/sec to 5 rad/sec was measured at 20° C. with a PHYSICA MCR300 rheometer manufactured by Paar Physica using a corn plate (CP 75-1 manufactured by Paar Physica) having a corn radius of 37.50 mm, a corn angle of 1 degree, and a measuring gap of 0.05 mm. The storage modulus at 0.6 rad/sec was taken as G′_{ω=0.6}, and the storage modulus at 0.8 rad/sec was taken as G′_{ω=0.8}. The dispersibility of the ink was evaluated according to the following criteria:

A: The value of (logG′_{ω=0.8}−logG′_{ω=0.6})/(log0.8−log0.6) is from 1.8 to 2.0.

B: The value of (logG′_{ω=0.8}−logG′_{ω=0.6})/(log0.8−log0.6) is from 1.6 to 1.8.

C: The value of (logG′_{ω=0.8}−logG′_{ω=0.6})/(log0.8−log0.6) is from 1.2 to 1.6.

D: The value of (logG′_{ω=0.8}−logG′_{ω=0.6})/(log0.8−log0.6) is less than 1.2.

Evaluation 1-2: Dispersibility 2

For each of the inks for ink jet recording of Examples and Comparative Examples, the viscosity at angles of inclination of 70°, 60°, 50°, 40° and 30° was measured with an AMVn rolling ball viscometer at 20° C., using a capillary having an inner diameter of 0.9 mm and a steel ball having a diameter of 0.794 mm and a density of 7.850 g/cm³. The sin θ was plotted as abscissa and the viscosity as ordinate. The slope of the resulting sin O-viscosity curve was determined, and the dispersibility of the ink was evaluated according to the following criteria:

A: The slope of the sin θ-viscosity curve is from 0 to −0.05, and the ink indicates Newtonian properties and shows particularly good dispersibility.

B: The slope of the sin θ-viscosity curve is from −0.05 to −0.1, and the ink indicates nearly Newtonian properties and shows good dispersibility next to that of A.

C: The slope of the sin θ-viscosity curve is from −0.1 to −0.15, and the ink indicates non-Newtonian properties, but shows slightly good dispersibility.

D: The slope of the sin θ-viscosity curve is less than −0.15, and the ink indicates non-Newtonian properties. Sedimentation easily occurs to show poor dispersibility.

Evaluation 2: Dispersion Stability

Each of the inks for ink jet recording of Examples and Comparative Examples was put into a glass sample bottle, sealed, and then, allowed to stand at 60° C. for 2 weeks. The viscosity of the ink before and after the standing was examined. The viscosity at a shear rate of 150/S was measured was measured at 20° C. with a PHYSICA MCR300 rheometer manufactured by Paar Physica using a corn plate (CP 75-1 manufactured by Paar Physica) having a corn radius of 37.50 mm, a corn angle of 1# and a measuring gap of 0.05 mm. The results thus obtained were evaluated according to the following criteria:

A: The change is less than ±0.1 mPa·s.

B: The change is from ±0.1 to ±0.3 mPa·s.

C: The change is ±0.3 mPa·s or more.

Evaluation 3: Sedimentation Properties

For each of the inks for ink jet recording of Examples and Comparative Examples, the sedimentation properties of the colorant in the ink were measured at 20° C. using a TURBISCAN 2000 instrument (manufactured by FORMUL ACTION) which can evaluate the sedimentation properties from intensity distributions of back scattered light and transmitted light in the height direction of the sample. A measurement principle of the TURBISCAN 2000 instrument manufactured by FORMUL ACTION is shown below. This instrument has the mechanism that when a glass tube into which an ink is put is set to a specified position of the instrument and a measurement is started, a stage disposed so as to surround the periphery (diameter direction) of the glass tube moves up and down along the glass tube. A light source and detectors for scattered light and transmitted light installed on the stage measure the intensity distributions of scattered light and transmitted light at 40-μm intervals in the longitudinal direction of the glass tube, in response to the vertical movement of the stage. This operation is repeated at arbitrary time intervals, thereby being able to observe the movement of particles or changes in particle diameter as the intensity of light with time.

The evaluation was made according to the following criteria:

A: No sedimentation phenomenon was observed even after the elapse of 2 weeks.

B: A sedimentation phenomenon was observed after the elapse of 2 weeks.

Evaluation 4: Print Density

An ink cartridge was filled with each of the inks for ink jet recording of Examples and Comparative Examples, and mounted on an ink jet printer, PM-720C (manufactured by Seiko Epson Corporation). A solid print was made on Xerox P paper (manufactured by Xerox Corp.) of plain paper. The density of this solid print portion was measured with a spectrophotometer (GRETAGA SPM-50, manufactured by Gretag Macbeth GmbH). The results thus obtained were evaluated according to the following criteria:

A: The OD value of the color ink is 1.2 or more.

B: The OD value of the color ink is 1.15 to less than 1.2.

C: The OD value of the color ink is less than 1.15.

Evaluation 5: Print Quality

An ink cartridge was filled with each of the inks for ink jet recording of Examples and Comparative Examples, and mounted on an ink jet printer, PM-720C (manufactured by Seiko Epson Corporation). Twenty-four capital letters and 24 lowercase letters of the alphabet were printed on each plain paper (partly including recycled paper) described below, visually observed and evaluated according to the following criteria:

AA: No blurring occurs on all papers.

A: The occurrence of slight blurring is only observed on 2 or 3 papers.

B: The occurrence of slight blurring is observed on all papers.

C: Much blurring occurs on all papers.

Print papers used for the evaluation are 12 papers of Conqueror, Favorit, Modo, Rapid Copy, EPSON EPP, Xerox P, Xerox 4024, Xerox 10, Neenha Bond, Ricopy 6200, Yamayuri (recycled paper) and Xerox R (recycled paper).

Evaluation 6: Color Developability

An ink cartridge was filled with each of the inks for ink jet recording of Examples and Comparative Examples, and mounted on an ink jet printer, PM-720C (manufactured by Seiko Epson Corporation). A solid print was made on each of semigloss MC photo paper (manufactured by Seiko Epson Corporation) and Xerox P paper (manufactured by Xerox Corp.), and the C* value of the sold print portion was measured. The ratio of the C* value on the Xerox P paper (manufactured by Xerox Corp.) to the C* value on the semigloss MC photo paper (manufactured by Seiko Epson Corporation) was determined, and the color developability on plain paper was evaluated according to the following criteria:
A: 0.9 or more
B: 0.8 to less than 0.9
C: Less than 0.8
   Evaluation 7: Abrasion Resistance

An ink cartridge was filled with each of the inks for ink jet recording of Examples and Comparative Examples, and mounted on an ink jet printer, PM-720C (manufactured by Seiko Epson Corporation). A solid print was made in a region of 10 mm×10 mm on a super fine glossy film designed for ink jet printing (manufactured by Seiko Epson Corporation) at a duty of 100%. %. After standing at a temperature of 25° C. for 1 hour, the above-mentioned printed region was rubbed with a yellow highlight pen using an aqueous ink (ZEBRA PEN2 (trade name), manufactured by Zebra Pen Corporation) at a load of 500 g and at a speed of 10 mm/sec, and it was observed whether a stain occurred or not. The results thereof were evaluated according to the following criteria:

A: No stain occurs at all when the printed region was rubbed twice.

B: No stain occurs when the printed region was rubbed once, but a stain occurs when it was rubbed twice.

C: A stain occurs when the printed region was rubbed once.

Evaluation 8: Water Resistance

One milliliter of ion exchanged water was dropped on the printed portion of the printed matter obtained in the print density test of evaluation 4. The state after 20 minutes was visually observed, and evaluated according to the following criteria:

A: No change occurs on all papers.

B: A colorant slightly bleeds out of the printed portion, but the recognition of letters is possible.

C: A colorant bleeds out of the printed portion to make the contours of printed letters unclear, so that the recognition of the letters is difficult.

Evaluation 9: Ejection Stability

Each of the inks for ink jet recording of Examples and Comparative Examples was mounted on an ink jet printer, PM-720C (manufactured by Seiko Epson Corporation), and 1-mm ruled lines were printed on super fine paper designed for ink jet printing (manufactured by Seiko Epson Corporation). The state of printing such as dot missing and deviation in ink landing position was visually observed, and evaluated according to the following criteria:

A: Even when 10,000 or more prints are carried out, neither dot missing nor deviation from the ink landing position occurs.

B: When 1,000 to less than 10,000 prints are carried out, dot missing or deviation from the ink landing position occurs.

C: When 100 to less than 1,000 prints are carried out, dot missing or deviation from the ink landing position occurs.

D: When less than 100 prints are carried out, dot missing or deviation from the ink landing position occurs.

Evaluation 10: Clogging Reliability

After the printing conducted in the above-mentioned evaluation 5, a power supply of the printer was turned off, and the ink was allowed to stand. After one week, the same printing test was conducted. The “state of ink ejection” at that time was visually observed, and evaluated according to the following criteria:

A: Normal printing starts without a cleaning operation at the same time that print signals are transmitted to the printer.

B: Normal printing is conducted after three or less cleaning operations.

C: Normal printing is conducted after six or less cleaning operations.

D: Normal printing cannot be conducted even when a cleaning operation is repeated seven or more times.

Evaluation 11: White Blank

An ink cartridge was filled with each of the inks for ink jet recording of Examples and Comparative Examples, and mounted on an ink jet printer, PM-720C (manufactured by Seiko Epson Corporation). A solid print was made on each plain paper used in evaluation 5. This solid print portion was visually observed, and evaluated according to the following criteria:

A: Fine portions in which the ink does not spread on the solid print portion to cause the original color of the paper to appear (referred to as white blanks in this specification) are not observed at all.

B: Fine portions in which the ink does not spread on the solid print portion to cause the original color of the paper to appear are slightly observed.

C: Fine portions in which the ink does not spread on the solid print portion to cause the original color of the paper to appear are observed.

D: Fine portions in which the ink does not spread on the solid print portion to cause the original color of the paper to appear are observed in large numbers.

Evaluation 12: Glossiness

An ink cartridge was filled with each of the inks for ink jet recording of Examples and Comparative Examples, and mounted on an ink jet printer, PM-720C (manufactured by Seiko Epson Corporation). A solid print was made on PM Photographic Paper (trade name, manufactured by Seiko Epson Corporation) at a duty of 100%. As a measuring instrument, there was used “GP-200” manufactured by Murakami Shikizai Kenkyusho (Murakami Colorant Laboratory). The maximum value of the glossiness was measured under the measuring conditions of 12 V, 50 W, an incident luminous flux aperture diameter of 1 mm, a reflected luminous flux aperture diameter of 1.5 mm, the use of an ND 10 filter, an incident light of 45 degrees, a flap angle of 0 degree and a standard mirror surfacing plate of 42.5. From the results thus obtained, the gloss of an image prepared using each ink composition was evaluated according to the following criteria:

A: The ink has a high gloss.

B: The ink has a gloss.

C: Te ink has a poor gloss.

TABLE 7

| | Evaluation | Evaluation | Evaluation | Evaluation | Evaluation | Evaluation | Evaluation |
|---|---|---|---|---|---|---|---|
| | 1-1 | 1-2 | 2 | 3 | 4 | 5 | 6 |
| | Dispersi- | Dispersi- | Dispersion | Sedimentation | Print | Print | Color |
| | bility 1 | bility 2 | Stability | Properties | Density | Quality | Developability |
| Example 1 | A | A | A | A | A | A | A |
| Example 2 | A | A | A | A | A | A | A |
| Example 3 | A | A | A | A | A | A | A |
| Example 4 | A | A | A | A | A | A | A |
| Example 5 | A | A | A | A | A | A | A |
| Example 6 | A | A | A | A | A | A | A |
| Example 7 | A | A | A | A | A | A | A |
| Example 8 | A | A | A | A | A | A | A |
| Example 9 | A | A | A | A | AA | AA | A |
| Example 10 | A | A | A | A | AA | AA | A |

| | Evaluation | Evaluation | Evaluation | Evaluation | Evaluation | Evaluation |
|---|---|---|---|---|---|---|
| | 7 | 8 | 9 | 10 | 11 | 12 |
| | Abrasion | Water | Ejection | Clogging | White | Glossi- |
| | Resistance | Resistance | Stability | Reliability | Blank | ness |
| Example 1 | B | A | A | A | A | B |
| Example 2 | B | A | A | A | A | B |
| Example 3 | B | A | A | A | A | B |
| Example 4 | A | A | A | A | A | B |
| Example 5 | A | A | A | A | A | B |
| Example 6 | A | A | A | A | A | B |
| Example 7 | B | A | A | A | A | B |
| Example 8 | A | A | A | A | A | B |
| Example 9 | B | A | A | A | A | A |
| Example 10 | A | A | A | A | A | A |

TABLE 8

| | Evaluation | Evaluation | Evaluation | Evaluation | Evaluation | |
|---|---|---|---|---|---|---|
| | 1-1 | 1-2 | 2 | 3 | 4 | Evaluation |
| | Dispersi- | Dispersi- | Dispersion | Sedimentation | Print | 5 |
| | bility 1 | bility 2 | Stability | Properties | Density | Print Quality |
| Com. Ex. 1 | B | B | B | A | C | C |
| Com. Ex. 2 | A | A | A | A | C | C |
| Com. Ex. 3 | A | A | A | A | C | C |
| Com. Ex. 4 | A | A | A | A | C | C |
| Com. Ex. 5 | C | C | C | B | B | C |
| Com. Ex. 6 | B | B | B | A | B | C |
| Com. Ex. 7 | C | C | C | B | B | C |
| Com. Ex. 8 | B | B | B | A | B | C |
| Com. Ex. 9 | A | A | A | A | A | A |
| Com. Ex. 10 | A | A | A | A | A | A |
| Com. Ex. 11 | A | A | A | A | A | A |
| Com. Ex. 12 | A | A | A | A | A | A |
| Com. Ex. 13 | A | A | A | A | A | A |

| | Evaluation | Evaluation | Evaluation | Evaluation | Evaluation | Evaluation |
|---|---|---|---|---|---|---|
| | 6 | 7 | 8 | 9 | 10 | 11 |
| | Color | Abrasion | Water | Ejection | Clogging | White |
| | Developability | Resistance | Resistance | Stability | Reliability | Blank |
| Com. Ex. 1 | — | B | A | B | C | C |
| Com. Ex. 2 | B | B | A | A | B | C |
| Com. Ex. 3 | B | B | A | A | B | C |
| Com. Ex. 4 | B | B | A | A | B | C |
| Com. Ex. 5 | — | A | A | C | C | C |
| Com. Ex. 6 | B | A | A | B | C | C |
| Com. Ex. 7 | B | A | A | C | C | C |
| Com. Ex. 8 | B | A | A | B | C | C |
| Com. Ex. 9 | — | C | A | A | A | A |
| Com. Ex. 10 | — | C | A | A | A | A |
| Com. Ex. 11 | A | C | A | A | A | A |
| Com. Ex. 12 | A | C | A | A | A | A |
| Com. Ex. 13 | A | C | A | A | A | A |

TABLE 9

| | Evaluation | Evaluation | Evaluation | Evaluation | Evaluation | | Evaluation |
|---|---|---|---|---|---|---|---|
| | 1-1 | 1-2 | 2 | 3 | 4 | Evaluation | 6 |
| | Dispersi- | Dispersi- | Dispersion | Sedimentation | Print | 5 | Color |
| | bility 1 | bility 2 | Stability | Properties | Density | Print Quality | Developability |
| Com. Ex. 14 | D | D | D | B | C | C | — |
| Com. Ex. 15 | D | D | D | B | C | D | — |
| Com. Ex. 16 | D | D | D | B | C | D | C |
| Com. Ex. 17 | D | D | D | B | C | C | C |
| Com. Ex. 18 | D | D | D | B | C | D | C |
| Com. Ex. 19 | B | B | B | A | C | D | — |
| Com. Ex. 20 | A | A | A | A | C | D | C |
| Com. Ex. 21 | A | A | A | A | C | D | C |
| Com. Ex. 22 | A | A | A | A | C | D | C |
| Com. Ex. 23 | C | C | C | B | B | D | — |
| Com. Ex. 24 | C | C | C | B | B | D | B |
| Com. Ex. 25 | C | C | C | B | B | D | B |
| Com. Ex. 26 | C | C | C | B | B | D | B |
| Com. Ex. 27 | A | A | A | B | — | — | — |

| | Evaluation | Evaluation | Evaluation | Evaluation | Evaluation | Evaluation |
|---|---|---|---|---|---|---|
| | 7 | 8 | 9 | 10 | 11 | 12 |
| | Abrasion | Water | Ejection | Clogging | White | Glossi- |
| | Resistance | Resistance | Stability | Reliability | Blank | ness |
| Com. Ex. 14 | C | B | D | D | D | C |
| Com. Ex. 15 | C | B | D | D | D | C |
| Com. Ex. 16 | C | B | D | D | D | C |
| Com. Ex. 17 | C | B | D | D | D | C |
| Com. Ex. 18 | C | B | D | D | D | C |
| Com. Ex. 19 | B | B | B | C | C | B |
| Com. Ex. 20 | C | B | B | C | C | B |
| Com. Ex. 21 | B | B | B | C | C | B |
| Com. Ex. 22 | C | B | B | C | C | B |
| Com. Ex. 23 | — | B | D | D | C | C |
| Com. Ex. 24 | C | B | D | D | C | C |
| Com. Ex. 25 | B | B | D | D | C | C |
| Com. Ex. 26 | C | B | D | D | C | C |
| Com. Ex. 27 | — | — | — | — | — | C |

As shown in Tables 7 to 9, the inks for ink jet recording of Examples were excellent in all evaluation items.

In particular, the solid wetting agent-containing inks for ink jet recording of Examples 1 to 8 and Comparative Examples 24 to 26 showed good results in clogging reliability.

The inks for ink jet recording of Comparative Examples 14 to 18 obtained by dispersing the pigments with the dispersants were insufficient in dispersibility, dispersion stability, print density, print quality, color developability, abrasion resistance and ejection stability. The inks for ink jet recording of Comparative Examples 1 to 4 and 19 to 22 in which the conventional microencapsulated pigments were used as colorants and the concentration of the microencapsulated pigments was set to a value lower than that of the inks of Examples were excellent in dispersion stability and ejection stability, but failed to obtain sufficient results for print density, print quality, abrasion resistance and color developability, the evaluations to the resulting recorded matter.

On the other hand, the inks for ink jet recording of Comparative Examples 5 to 8 and 23 to 26 in which the above-mentioned conventional microencapsulated pigments were used as colorants and the concentration of the microencapsulated pigments was set to a value equivalent to that of the inks of Examples were particularly poor in dispersibility, dispersion stability and ejection stability. Further, the inks for ink jet recording of Comparative Examples 9 to 13 containing the surface-treated pigments as the colorants were excellent in dispersion stability and ejection stability, but poor in abrasion resistance.

It was impossible to print the ink of Comparative Example 27 with an ink jet printer, because the microencapsulated pigment (MCP11) had a particle size of 7 μm.

### Examples 9 and 10

Inks for ink jet recording of Examples 9 and 10 were prepared based on compositions shown in Table 10.

TABLE 10

| | | Example 9 | Example 10 |
|---|---|---|---|
| Microencapsulated | MCP20 | 6 | |
| Pigment | MCP21 | | 6 |
| Wetting Agent | Glycerol | 12 | 13 |
| Penetrant | Diethylene glycol | | 3 |
| Solid Wetting Agent | monobutyl ether | | |
| | Triethylene glycol | 3 | |
| | monobutyl ether | | |
| | 1,2-Hexanediol | 3 | 2 |
| | Trimethylolpropane | 3 | 2 |
| | 1,2,6-Hexanetriol | | 1 |
| Polar Solvent | 2-Pyrrolidone | | 1 |
| Surfactant | Olfine E1010 | 1 | 1 |
| pH Adjuster | Potassium hydroxide | 0.1 | 0.1 |
| Preservative | Proxel XL-2 | 0.05 | 0.05 |
| Water | Ion exchanged water | bal. | bal. |

The amounts added are all indicated by % by weight.

The amounts of the microencapsulated pigments are indicated by the solid concentration.

The above-mentioned evaluations 1 to 11 were carried out for the inks for ink jet recording of Examples 9 and 10. As a result, excellent inks for ink jet recording were obtained similarly to Examples 1 to 8. The results thereof are shown in Table 7.

Further, for the inks of Examples 9 and 10 and the inks prepared in some of Comparative Examples described above, the viscosity was measured by the following method. The results thereof are shown in Table 11.

Measurement of Viscosity:

The viscosity of the inks prepared as described above in Examples 9 and 10 and the inks prepared in some of Comparative Examples described above was measured. The results thereof are shown in the following table.

The viscosity (mPa·s) of the inks for ink jet recording of Examples and Comparative Examples at a shear rate of 20 sec⁻¹ at 20° C. was measured with a PHYSICA MCR300 rheometer manufactured by Paar Physica using a corn plate (CP 75-1 manufactured by Paar Physica) having a corn radius of 37.50 mm, a corn angle of 1 degree and a measuring gap of 0.05 mm.

TABLE 11

| | | | Comp. | Comp. | Comp. | Comp. | Comp. |
|---|---|---|---|---|---|---|---|
| | Example | Example | Example | Example | Example | Example | Example |
| | 9 | 10 | 8 | 15 | 16 | 17 | 18 |
| Viscosity | 2.50 | 2.80 | 5.00 | 7.50 | 6.80 | 7.20 | 6.50 |
| (mPa · s) | | | | | | | |

The above results reveal that the viscosity of the inks for ink jet recording can be significantly decreased by the purification treatment of the microencapsulated pigment-containing aqueous dispersions.

While the present invention has been described in detail and with reference to specific embodiments thereof, it will be apparent to one skilled in the art that various changes and modifications can be made therein without departing from the spirit and scope thereof.

This application is based on Japanese Patent Application Nos. 2003-044642 (filed Feb. 21, 2003), 2003-307852 (filed Aug. 29, 2003) and 2004-43396 (filed Feb. 19, 2004), the contents thereof being herein incorporated by reference.

1. A process for preparing a microencapsulated pigment, which comprises adding a polymerizable surfactant having a hydrophilic group, a hydrophobic group and a polymerizable group, a polymerization initiator and an aqueous medium to a wet pigment, and conducting emulsion polymerization to encapsulate pigment particles with a polymer.

2. A process for preparing a microencapsulated pigment, which comprises adding a polymerizable surfactant having a hydrophilic group, a hydrophobic group and a polymerizable group, a comonomer copolymerizable with the above-mentioned polymerizable surfactant, a polymerization initiator and an aqueous medium to a wet pigment, and conducting emulsion polymerization to encapsulate pigment particles with a copolymer.

3. The process described in the above [2], wherein the above-mentioned comonomer is a hydrophilic monomer and/or a hydrophobic monomer.

4. The process described in the above [3], wherein the above-mentioned hydrophobic monomer has at least a hydrophobic group and a polymerizable group in its structure, and the hydrophobic group is selected from the group consisting of aliphatic hydrocarbon groups, alicyclic hydrocarbon groups and aromatic hydrocarbon groups.

5. The process described in the above [3], wherein the above-mentioned hydrophilic monomer has at least a hydrophilic group and a polymerizable group in its structure, and the hydrophilic group is selected from the group consisting of a sulfonic acid group, a sulfinic acid group, a carboxyl group, a carbonyl group, salts of these groups, a hydroxyl group, an oxyethylene group, an amido group and an amino group.

6. The process described in claim 2, wherein the polymerizable group of the above-mentioned comonomer is a radically polymerizable unsaturated hydrocarbon group selected from the group consisting of a vinyl group, an allyl group, an acryloyl group, a methacryloyl group, a propenyl group, a vinylidene group and a vinylene group.

7. The process described in claim 1, wherein the pigment constituting the above-mentioned pigment particles is carbon black or an organic pigment.

8. The process described in claim 1, wherein the polymerizable group of the above-mentioned polymerizable surfactant is a group selected from the group consisting of a vinyl group, an allyl group, an acryloyl group, a methacryloyl group, a propenyl group, a vinylidene group and a vinylene group.

9. The process described in claim 1, wherein the hydrophilic group of the above-mentioned polymerizable surfactant is an anionic group selected from the group consisting of a sulfonic acid group, a sulfinic acid group, a carboxyl group, a carbonyl group and salts of these groups, and/or a nonionic group selected from the group consisting of a hydroxyl group and an oxyethylene group.

10. The process described in claim 1, wherein the hydrophobic group of the above-mentioned polymerizable surfactant is a group selected from the group consisting of alkyl groups, aryl groups and combinations thereof.

11. A microencapsulated pigment obtained by using the process according to claim 1.

12. The microencapsulated pigment described in the above [11], which has an aspect ratio of 1.0 to 1.3, and a Zingg index of 1.0 to 1.3.

13. An aqueous dispersion containing the microencapsulated pigment described in the above [11].

14. An ink for ink jet recording containing the aqueous dispersion described in the above [13].

15. An ink for ink jet recording containing an aqueous dispersion of a microencapsulated pigment in which pigment particles are encapsulated with a polymer,
wherein the above-mentioned microencapsulated pigment is formed by adding a polymerizable surfactant having a hydrophilic group, a hydrophobic group and a polymerizable group, a polymerization initiator and an aqueous medium to a wet pigment, and conducting emulsion polymerization, and
wherein the above-mentioned aqueous dispersion has been subjected to purification treatment, and the concentration of unreacted polymerizable surfactant after the above-mentioned purification treatment is 50000 ppm or less based on the aqueous component in the above-mentioned aqueous dispersion.

16. An ink for ink jet recording containing an aqueous dispersion of a microencapsulated pigment in which pigment particles are encapsulated with a polymer,
wherein the above-mentioned microencapsulated pigment is formed by adding a polymerizable surfactant having a hydrophilic group, a hydrophobic group and a polymerizable group, a comonomer copolymerizable with the above-mentioned polymerizable surfactant, a polymerization initiator and an aqueous medium to a wet pigment, and conducting emulsion polymerization, and
wherein the above-mentioned aqueous dispersion has been subjected to purification treatment, and the total concentration of unreacted polymerizable surfactant and comonomer after the above-mentioned purification treatment is 50000 ppm or less based on the aqueous component in the above-mentioned aqueous dispersion.

17. An ink for ink jet recording containing at least the microencapsulated pigment described in the above [11] and water.

18. The ink for ink jet recording described in any one of the above [14] to [17], further containing a water-soluble organic solvent.

19. The ink for ink jet recording described in the above [18], wherein the above-mentioned water-soluble organic solvent is a high boiling water-soluble organic solvent having a boiling point of 180 C or higher.

20. The ink for ink jet recording described in the above [18], wherein the above-mentioned water-soluble organic solvent contains at least one compound selected from the group consisting of glycerol, an alkyl ether of a polyhydric alcohol and an 1,2-alkyldiol.

21. The ink for ink jet recording described in any one of the above [14], further containing a solid wetting agent in an amount of 3% to 20% by weight based on the total weight of the above-mentioned ink for ink jet recording.

22. The ink for ink jet recording described in the above [21], wherein the above-mentioned solid wetting agent is trimethylolpropane and/or 1,2,6-hexanetriol.

23. The ink for ink jet recording described in any one of the above 15, further containing a solid wetting agent in an amount of 3% to 20% by weight based on the total weight of the above-mentioned ink for ink jet recording.

24. The ink for ink jet recording described in the above [23], wherein the above-mentioned surfactant is an acetylene glycol-based surfactant and/or an acetylene alcohol-based surfactant.

25. The ink for ink jet recording described in any one of the above [14], further containing a saccharide.

26. The process described in claim 2, wherein the pigment constituting the above-mentioned pigment particles is carbon black or an organic pigment.

27. The process described in claim 2, wherein the polymerizable group of the above-mentioned polymerizable surfactant is a group selected from the group consisting of a vinyl group, an allyl group, an acryloyl group, a methacryloyl group, a propenyl group, a vinylidene group and a vinylene group.

28. The process described in claim 2, wherein the hydrophilic group of the above-mentioned polymerizable surfactant is an anionic group selected from the group consisting of a sulfonic acid group, a sulfinic acid group, a carboxyl group, a carbonyl group and salts of these groups, and/or a nonionic group selected from the group consisting of a hydroxyl group and an oxyethylene group.

29. The process described in claim 2, wherein the hydrophobic group of the above-mentioned polymerizable surfactant is a group selected from the group consisting of alkyl groups, aryl groups and combinations thereof.

30. A microencapsulated pigment obtained by using the process according to claim 2.

31. The ink for ink jet recording described in any one of the above 15, further containing a solid wetting agent in an amount of 3% to 20% by weight based on the total weight of the above-mentioned ink for ink jet recording.

32. The ink for ink jet recording described in any one of the above 15, further containing a solid wetting agent in an amount of 3% to 20% by weight based on the total weight of the above-mentioned ink for ink jet recording.

33. The ink for ink jet recording described in any one of the above 17, further containing a solid wetting agent in an amount of 3% to 20% by weight based on the total weight of the above-mentioned ink for ink jet recording.

34. The ink for ink jet recording described in any one of the above 15, further containing a solid wetting agent in an amount of 3% to 20% by weight based on the total weight of the above-mentioned ink for ink jet recording.

35. The ink for ink jet recording described in any one of the above 16, further containing a solid wetting agent in an amount of 3% to 20% by weight based on the total weight of the above-mentioned ink for ink jet recording.

36. The ink for ink jet recording described in any one of the above 17, further containing a solid wetting agent in an amount of 3% to 20% by weight based on the total weight of the above-mentioned ink for ink jet recording.

37. The ink for ink jet recording described in any one of the above [14], further containing a saccharide.

38. The ink for ink jet recording described in any one of the above [16], further containing a saccharide.

39. The ink for ink jet recording described in any one of the above [17], further containing a saccharide.
